(19) United States
(12) Patent Application Publication
(10) Pub. No.: US 2011/0224978 A1
(43) Pub. Date: Sep. 15, 2011

(54) INFORMATION PROCESSING DEVICE, INFORMATION PROCESSING METHOD AND PROGRAM

(76) Inventor: Tsutomu SAWADA, Tokyo (JP)

(21) Appl. No.: 13/038,104

(22) Filed: Mar. 1, 2011

(30) Foreign Application Priority Data
Mar. 11, 2010 (JP) P2010-054016

(51) Int. Cl. G10L 15/00

(52) U.S. Cl. 704/231; 704/E15.001

(57) ABSTRACT

An information processing device includes an audio-based speech recognition processing unit which is input with audio information as observation information of a real space, executes an audio-based speech recognition process, thereby generating word information that is determined to have a high probability of being spoken, an image-based speech recognition processing unit which is input with image information as observation information of the real space, analyzes mouth movements of each user included in the input image, thereby generating mouth movement information, an audio-image-combined speech recognition score calculating unit which is input with the word information and the mouth movement information, executes a score setting process in which a mouth movement close to the word information is set with a high score, thereby executing a score setting process, and an information integration processing unit which is input with the score and executes a speaker specification process.

### BACKGROUND OF THE INVENTION

1. Field of the Invention

The present invention relates to an information processing device, an information processing method, and a program. More specifically, the invention relates to an information processing device, an information processing method, and a program which enable to input information such as images and sounds from the external environment and to analyze the external environment based on the input information, specifically, to specify the position of an object and identify the object such as a speaking person.

2. Description of the Related Art

A system that performs communication or interactive processes between a person and an information processing device such as a PC or a robot is called a man-machine interaction system. In such a man-machine interaction system, an information processing device such as a PC or a robot receives image information or audio information, analyzes the received information, and identities motions or voice of a person.

When a person delivers information, a diverse range of channels including not only words but also gestures, directions of sight, facial expressions or the like are used as information delivery channel. If a machine can perform an analysis of all the channels, communication between a person and a machine can be achieved at the same level as that between people. An interface which performs the analysis of input information from such plurality of channels (hereinafter also referred to as modality or modal) is called a multi-modal interface, and development and research thereof have been actively conducted in recent years.

When image information photographed by a camera and audio information acquired by a microphone are to be input and analyzed, for example, it is effective to input a large amount of information from a plurality of cameras and microphones installed at various points in order to perform in-depth analysis.

As a specific system, for example, a system as below can be supposed. A feasible system is an information processing device (television) which is input with images and voices of users (father, mother, sister, and brother) in front of the television through a camera and a microphone, analyzes where each user is located, which user spoke words, and the like, and performs a process, for example, zoom-in of the camera toward a user who made conversation, correct responses to the conversation of the user, and the like according to the analyzed information input thereto.

Most general man-machine interaction systems in the related art performed processes such as deterministically integrating information from the plurality of channels (modals) and determining where each of the users is located, who they are, and who sent the signals. With respect to the related art introducing such a system, there are Japanese Unexamined Patent Application Publication Nos. 2005-271137 and 2002-264051, as examples.

However, in such a deterministic integrating processing method which uses uncertain and asynchronous data input from cameras and microphones in the systems of the related art, it is problematic in that only data of insufficient robustness and low accuracy can be obtained. In an actual system, sensor information that can be acquired from the real environment, in other words, input image from cameras or audio information audio information input from microphones include excess information which is uncertain data containing, for example, noise and unnecessary information, and when the process of image analysis or voice analysis is to be performed, it is important to efficiently integrate useful information from such sensor information.

The present applicant has filed an application of Japanese Unexamined Patent Application Publication No. 2009-140366 as a configuration to solve the problem. The configuration disclosed in Japanese Unexamined Patent Application Publication No. 2009-140366 is for performing a particle filtering process based on audio and image event detection information and a process of specifying user position or user identification. The configuration realizes specification of user position and user identification by selecting reliable data with high accuracy from uncertain data containing noise or unnecessary information.

The device disclosed in Japanese Unexamined Patent Application Publication No. 2009-140366 further performs a process of specifying a speaker by detecting mouth movements obtained from image data. For example, that is a process in which a user showing active mouth movements is estimated to have a high probability of being a speaker. Scores according to mouth movements are calculated, and a user recorded with a high score is specified as a speaker. In this process, however, since only mouth movements are the subjects to be evaluated, there is a problem that a user chewing gum, for example, could also be recognized as a speaker.

### SUMMARY OF THE INVENTION

The invention takes, for example, the above-described problem into consideration, and it is desirable to provide an information processing device, an information processing method, and a program which enable the estimation of a user specifically speaking words as a speaker by using an audio-based speech recognition process in combination with an image-based speech recognition process for the estimation process of a speaker.

According to an embodiment of the invention, an information processing device includes an audio-based speech recognition processing unit which is input with audio information as observation information of a real space, executes an audio-based speech recognition process, and thereby generating word information that is determined to have a high probability of being spoken, an image-based speech recognition processing unit which is input with image information as observation information of the real space, analyzes mouth movements of each user included in the input image, and thereby generating mouth movement information in a unit of user, an audio-combined speech recognition score calculating unit which is input with the word information from the audio-based speech recognition processing unit and input with the mouth movement information in a unit of user from the image-based speech recognition processing unit, executes a score setting process in which mouth movements close to the word information are set with a high score, and thereby executing a score setting process in a unit of user, and an information integration processing unit which is input with the score and executes a speaker specification process based on the input score.

Furthermore, according to the embodiment of the invention, the audio-based speech recognition processing unit executes ASR (Audio Speech Recognition) that is an audio-based speech recognition process to generate a phoneme sequence of word information that is determined to have a high probability of being spoken as ASR information, the image-based speech recognition processing unit executes VSR (Visual Speech Recognition) that is an image-based speech recognition process to generate VSR information that includes at least viseme information indicating mouth shapes in a word speech period, and the audio-image-combined speech recognition score calculating unit compares the viseme information in a unit of user included in the VSR information with registered viseme information in a unit of phoneme constituting the word information included in the ASR information to execute a viseme score setting process in which a viseme with high similarity is set with a high score, and calculates an AVSR score which is a score corresponding to a user by the calculation process of an arithmetic mean value or a geometric mean value of a viseme score corresponding to all phonemes further constituting a word.

Furthermore, according to the embodiment of the invention, the audio-image-combined speech recognition score calculating unit performs a viseme score setting process corresponding to periods of silence before and after the word information included in the ASR information, and calculates an AVSR score which is a score corresponding to a user by the calculation process of an arithmetic mean value or a geometric mean value of a score including a viseme score corresponding to all phonemes constituting a word and a viseme score corresponding to a period of silence.

Furthermore, according to the embodiment of the invention, the audio-image-combined speech recognition score calculating unit uses values of prior knowledge that are set in advance as a viseme score for a period when viseme information indicating mouth movements of the word speech period is not input.

Furthermore, according to the embodiment of the invention, the information integration processing unit sets probability distribution data of a hypothesis on user information of the real space and executes a speaker specification process by updating and selecting a hypothesis based on the AVSR score.

Furthermore, according to the embodiment of the invention, the information processing device further includes an audio event detecting unit which is input with audio information as observation information of the real space and generates audio event information including estimated location information and estimated identification information of a user existing in the real space, and an image event detecting unit which is input with image information as observation information of the real space and generates image event information including estimated location information and estimated identification information of a user existing in the real space, and the information integration processing unit sets probability distribution data of a hypothesis on the location and identification information of a user and generates analysis information including location information of a user existing in the real space by updating and selecting a hypothesis based on the event information.

Furthermore, according to the embodiment of the invention, the information integration processing unit is configured to generate analysis information including location information of a user existing in the real space by executing a particle filtering process to which a plurality of particles set with multiple pieces of target data corresponding to virtual users is applied, and the information integration processing unit is configured to set each piece of the target data set in the particles in association with each event input from the audio and image event detecting units and to update the target data corresponding to the event selected from each particle according to an input event identifier.

Furthermore, according to the embodiment of the invention, the information integration processing unit performs a process by associating a target to each event in a unit of face image detected by the event detecting units.

Furthermore, according to another embodiment of the invention, an information processing method which is implemented in an information processing device includes the steps of processing audio-based speech recognition in which an audio-based speech recognition processing unit is input with audio information as observation information of a real space, executes an audio-based speech recognition process, thereby generating word information that is determined to have a high probability of being spoken, processing image-based speech recognition in which an image-based speech recognition processing unit is input with image information as observation information of a real space, analyzing the mouth movements of each user included in the input image, thereby generating mouth movement information in a unit of user, calculating an audio-image-combined speech recognition score in which an audio-image-combined speech recognition score calculating unit is input with the word information from the audio-based speech recognition processing unit and input with the mouth movement information in a unit of user from the image-based speech recognition processing unit, executes a score setting process in which a mouth movement close to the word information is set with a high score, thereby executing a score setting process in a unit of user, and processing information integration in which an information integration processing unit is input with the score and executes a speaker specification process based on the input score.

Furthermore, according to still another embodiment of the invention, a program which causes an information processing device to execute an information process includes the steps of processing audio-based speech recognition in which an audio-based speech recognition processing unit is input with audio information as observation information of a real space, executing an audio-based speech recognition process, thereby generating word information that is determined to have a high probability of being spoken, processing image-based speech recognition in which an image-based speech recognition processing unit is input with image information as observation information of a real space, analyzes the mouth movements of each user included in the input image, thereby generating mouth movement information in a unit of user, calculating an audio-image-combined speech recognition score in which an audio-image-combined speech recognition score calculating unit is input with the word information from the audio-based speech recognition processing unit and input with the mouth movement information in a unit of user from the image-based speech recognition processing unit, executing a score setting process in which a mouth movement close to the word information is set with a high score, and thereby executing a score setting process in a unit of user, and processing information integration in which an information integration processing unit is input with the score and executes a speaker specification process based on the input score.

In addition, the program of the invention is a program, for example, that can be provided by a recording medium or a communicating medium in a computer-readable form for information processing devices or computer systems that can implement various program codes. By providing such a program in a computer-readable form, processes according to the program are realized on such information processing devices or computer systems.

Still other objectives, characteristics, or advantages of the invention will be made clear by more detailed description based on the embodiment of the invention and accompanying drawings to be described later. In addition, the system in this specification is a logically assembled composition of a plurality of devices, and each of the constituent devices is not limited to be in the same housing.

According to a configuration of an embodiment of the invention, a speaker specification process can be realized by analyzing input information from a camera or a microphone. An audio-based speech recognition process and an image-based speech recognition process are executed. Furthermore, word information which is determined to have a high probability of being spoken is input to an audio-based speech recognition processing unit, viseme information which is analyzed information of mouth movements in a unit of user is input to an image-based speech recognition process, and a high score is set to the information when the information is close to mouth movements uttering each phoneme in a unit of phoneme constituting a word to set a score in a unit of user. Furthermore, a speaker specification process is performed based on scores by applying the scores in a unit of user. With the process, a user showing mouth movements close to the spoken content can be specified as the generation source, and speaker specification is realized with high accuracy.

### BRIEF DESCRIPTION OF THE DRAWINGS

FIG. 1 is a diagram illustrating an overview of a process executed by an information processing device according to an embodiment of the invention;

FIG. 2 is a diagram illustrating a composition and a process by the information processing device which performs a user analysis process;

FIG. 3A and FIG. 3B are diagrams illustrating an example of information generated by an audio event detecting unit 122 and an image event detecting unit 112 and input to an audio-image integration processing unit 131;

FIGS. 4A to 4C are diagrams illustrating a basic processing example to which a particle filter is applied;

FIG. 5 is a diagram illustrating the composition of a particle set in the processing example;

FIG. 6 is a diagram illustrating the composition of target data of each target included in each particle;

FIG. 7 is a diagram illustrating the composition and generation process of target information;

FIG. 8 is a diagram illustrating the composition and generation process of the target information;

FIG. 9 is a diagram illustrating the composition and generation process of the target information;

FIG. 10 is a diagram showing a flowchart for a process sequence of the execution by the audio-image integration processing unit 131;

FIG. 11 is a diagram illustrating a calculation process of a particle weight [W_{pID}] in detail;

FIG. 12 is a diagram illustrating the composition and process by an information processing device which performs a specification process of a speech source;

FIG. 13 is a diagram illustrating an example of a calculation process of an AVSR score for the specification process of the speech source;

FIG. 14 is a diagram illustrating an example of the calculation process of the AVSR score for the specification process of the speech source;

FIG. 15 is a diagram illustrating an example of a calculation process of an AVSR score for a specification process of a speech source;

FIG. 16 is a diagram illustrating an example of a calculation process of an AVSR score for a specification process of a speech source; and

FIG. 17 is a diagram showing a flowchart for a calculation process sequence of an AVSR score for a specification process of a speech source.

### DESCRIPTION OF THE PREFERRED EMBODIMENTS

Hereinafter, an information processing device, an information processing method, and a program according to an embodiment of the invention will be described in detail with reference to drawings. Description will be provided in accordance with the subjects below.

1. Regarding outline of user location and user identification processes by particle filtering based on audio and image event detection information
2. Regarding a speaker specification process in association with a score (AVSR score) calculation process by voice- and image-based speech recognition

Furthermore, the invention is based on the technology of Japanese Patent Application No. 2007-317711 (Japanese Unexamined Patent Application Publication No. 2009-140366) which is a previous application by the applicant, and the composition and outline of the invention disclosed therein will be described in the subject No. 1 above. After that, a speaker specification process in association with a score (AVSR score) calculation process by voice- and image-based speech recognition, which is the main subject of the present invention, will be described in the subject No. 2 above.

### [1. Regarding Outline of User Location and User Identification Process by Particle Filtering Based on Audio and Image Event Detection Information]

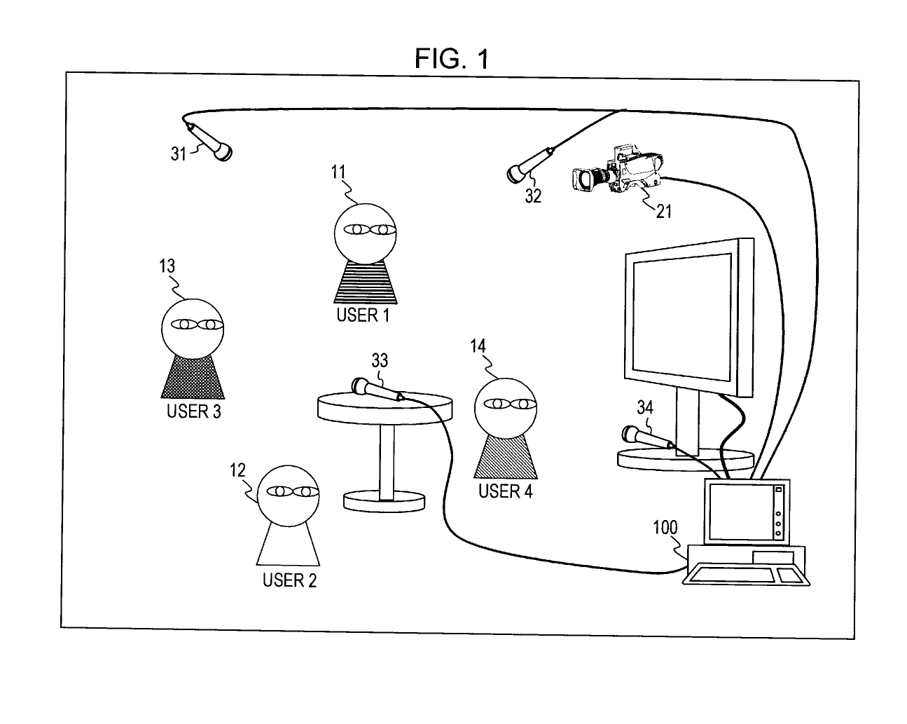

First of all, description will be provided for the outline of user location and user identification process by particle filtering using audio event and image event detection information. FIG. 1 is a diagram illustrating an overview of the process.

An information processing device 100 is input with various information from a sensor which inputs observed information from real space. In this example, the information processing device 100 is input with image information and audio information from a camera 21 and a plurality of microphones 31 to 34 as sensors and performs analysis of the environment based on the input information. The information processing device 100 analyzes the locations of a plurality of users 1 to 4 denoted by reference numerals 11 to 14 and identifies the users at these locations.

In the case where the reference numeral 11 of the user 1 to the reference numeral 14 of the user 4 are a family constituted by a father, a mother, a sister, and a brother, for example, in the example shown in the drawing, the information processing device 100 performs analysis of image and audio information input from the camera 21 and the plurality of microphones 31 to 34, determines the locations of the four users from the user 1 to user 4 and identifies whether the users in each of the locations are the father, the mother, the sister, or the brother. The identification process results are used in various processes. For example, the results are used in the processes of zoom-in by the camera toward the user who is speaking, giving responses from the television to the speech by the user.

The information processing device 100 performs a user identification process as user location and user identification specification process based on input information from a plurality of information input units (the camera 21 and microphones 31 to 34). The use of the identification results is not particularly limited. The image and audio information input from the camera 21 and the plurality of microphones 31 to 34 includes a variety of uncertain information. The information processing device 100 performs a probabilistic process for the uncertain information included in such input information and then carries out a process to integrate into the information estimated to be of high accuracy. With the estimation process, robustness is improved, and analysis can be performed with high accuracy.

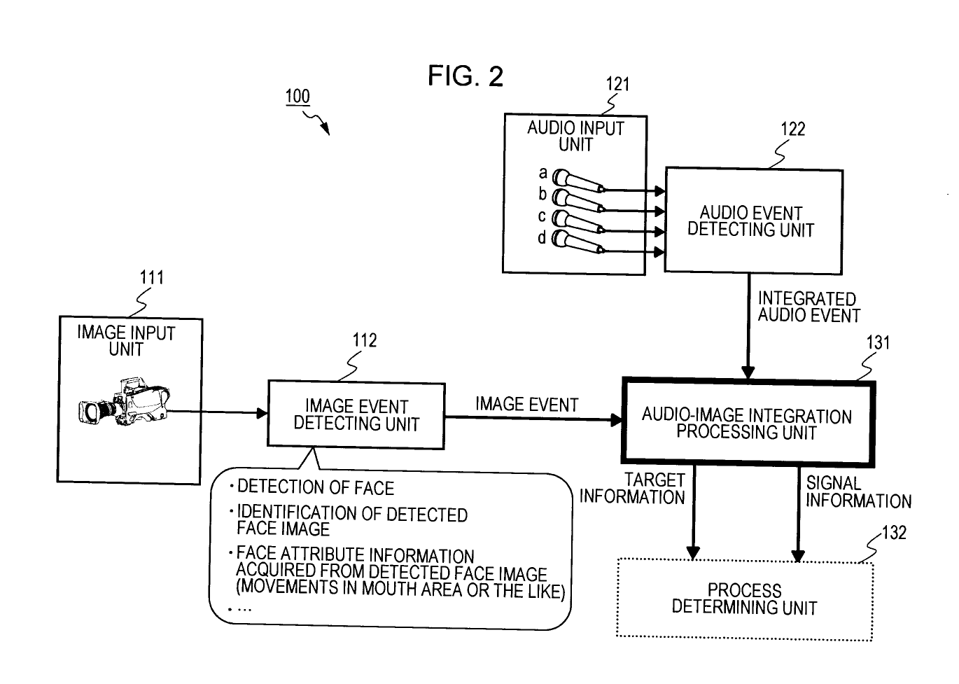

FIG. 2 shows a composition example of the information processing device 100. The information processing device 100 includes an image input unit (camera) 111 and a plurality of audio input units (microphones) 121a to 121d as input devices. Image information is input from the image input unit (camera) 111, audio information is input from the audio input units (microphones) 121, and analysis is performed based on the input information. Each of the plurality of audio input units (microphones) 121a to 121d are arranged in various locations as shown in FIG. 1.

The audio information input from the plurality of microphones 121a to 121d is input to an audio-image integration processing unit 131 via an audio event detecting unit 122. The audio event detecting unit 122 analyzes and integrates the audio information input from the plurality of audio input units (microphones) 121a to 121d arranged in a plurality of different locations. Specifically, the audio event detecting unit 122 generates user identification information regarding the location of produced sounds and which user produced the sound based on audio information input from the audio input units (microphones) 121a to 121d and inputs to the audio-image integration processing unit 131.

Furthermore, a specific process executed by the information processing device 100 is to identify, for example, where the users 1 to 4 are located, which user spoke in the environment where the plurality of users exist as shown in FIG. 1, in other words, to specify user locations and user identification, and performs a process of specifying an event generation source such as a person (speaker) who spoke a word.

The audio event detecting unit 122 analyzes audio information input from the plurality of audio input units (microphones) 121a to 121d arranged in different plural locations, and generates location information of audio generation sources as probability distribution data. Specifically, an expected value regarding the direction of an audio source and dispersion data N (mₑ, σₑ) are generated. In addition, user identification information is generated based on a comparison process with the information of voice characteristics of users that have been registered in advance. The identification information is generated as probabilistic estimation value. The audio event detecting unit 122 is registered with the information of voice characteristics of the plurality of users to be verified in advance, determines which user has the high probability of making the voice by executing the comparison process with the input voice and registered voice, and calculates a posterior probability or a score for all the registered users.

As such, the audio event detecting unit 122 analyzes the audio information input from the plurality of audio input units (microphones) 121a to 121d arranged in various different locations, generates “integrated audio event information” constituted by probability distribution data for the location information of the audio generation source and probabilistic estimation values for the user identification information to input to the audio-image integration processing unit 131.

On the other hand, the image information input from the image input unit (camera) 111 is input to the audio-image integration processing unit 131 via the image event detecting unit 112. The image event detecting unit 112 analyzes the image information input from the image input unit (camera) 111, extracts the face of a person included in an image, and generates face location information as probability distribution data. Specifically, an expected value and dispersion data N (mₑ, σₑ) regarding the location and direction of the face are generated.

In addition, the image event detecting unit 112 generates user identification information by identifying the face based on the comparison process with information of users' face characteristics that have been registered in advance. The identification information is generated as a probabilistic estimation value. The image event detecting unit 112 is registered with information of the plurality of users' face characteristics to be verified in advance, determines which user has the high probability to have the face by executing the comparison process with the characteristic information of the face area image extracted from the input image and characteristic information of registered face images, and calculates a posterior probability or a score for all the registered users.

Furthermore, the image event detecting unit 112 calculates an attribute score corresponding to the face included in the image input from the image input unit (camera) 111, for example a face attribute score generated based on, for example, movements of the mouth area.

The face attribute score can be calculated under such settings as below, for example:

(a) A score according to the extent of movements in the mouth area of the face included in an image; and

(b) A score according to a corresponding relationship between speech recognition and movements in the mouth area of the face included in an image.

In addition to these, the face attribute score can be calculated under such settings as whether the face is smiling or not, whether the face is of a woman or a man, whether the face is of an adult or a child, or the like.

Hereinbelow, description will be provided for an example in which the face attribute score is calculated and used as:

(a) the score corresponding to the movement of the mouth area of the face included in an image.

That is, a score corresponding to the extent of a movement in the mouth area of the face is calculated as a face attribute score, and a speaker specification process is performed based on the face attribute score.

As simply described above, however, in the process to calculate a score from the extent of a mouth movement, there is a problem in that the speech of a user giving a request to a system is not easily specified because the relevant mouth movements are not easily distinguished from the movements by a user who chews gum or speaks irrelevant words to the system.

In the subject No. 2 of the latter part, that is, <2. regarding the speaker specification process in association with a score (AVSR score) calculation process by voice- and image-based speech recognition>, description is provided for the calculation processing and speaker specification process of (b) a score according to a correspondence relationship between speech recognition and a movement in the mouth area of the face included in an image, as a way to solve the problem.

First, an example that (a) a score according to the extent of a movement in the mouth area of the face included in an image is calculated and used as a face attribute score is described in the subject no. 1.

The image event detecting unit 112 distinguishes the mouth area from the face area included in the image input from the image input unit (camera) 111, detects movements in the mouth area, and performs a process of giving scores corresponding to detection results of the movements in the mouth area, for example, giving a high score when the mouth is determined to have moved.

Furthermore, the process of detecting the movement in the mouth area is executed as a process to which VSD (Visual Speech Detection) is applied. It is possible to apply a method disclosed in Japanese Unexamined Patent Application Publication No. 2005-157679 of the same applicant as the invention. To be more specific, for example, left and right end points of the lips are detected from the face image which is detected from the input image from the image input unit (camera) 111, and in an N-th frame and an N+1-th frame, the left and right end points of the lips are aligned, and then the difference in luminance is calculated. By performing a threshold process on this difference value, the movement of the mouth can be detected.

Furthermore, technologies in the related art are applied to a process of voice identification, face detection and face identification executed by the audio event detecting unit 122 and the image event detecting unit 112. For example, the process of face detection and face identification can be applied with technologies disclosed in the following documents:

“Learning of an actual time arbitrary posture and face detector using pixel difference feature” by Kotaro Sabe and Kenichi Hidai, Proceedings of the 10^{th} Symposium on Sensing via Imaging Information, pp. 547-552, 2004

Japanese Unexamined Patent Application Publication No. 2004-302644 (P2004-302644A) [Title of the Invention: Face Identification Device, Face Identification Method, Recording Medium, and Robot Device]

The audio-image integration processing unit 131 executes a process of probabilistically estimating where each of the plurality of users is, who the users are, and which user gave a signal including speech based on the input information from the audio event detecting unit 122 and the image event detecting unit 112. The process will be described in detail later. The audio-image integration processing unit 131 inputs the following information to a process determining unit 132 based on the input information from the audio event detecting unit 122 and the image event detecting unit 112:

(a) Information for estimating where each of the plurality of users is and who the users are as [Target information]; and

(b) Event generation source such as user, for example, who speaks words as [Signal information].

The process determining unit 132 that receives the identification process results executes a process by using the identification process results, for example, a process of zoom-in of the camera toward a user who speaks, or response from a television to the speech made by a user.

As described above, the audio event detecting unit 122 generates probability distribution data of the information regarding the location of an audio generation source, specifically, an expected value for the direction of the audio source and dispersion data N (mₑ, σₑ). In addition, the unit generates user identification information based on the comparison process with information on characteristics of users' voices registered in advance and input the information to the audio-image integration processing unit 131.

In addition, the image event detecting unit 112 extracts the face of a person included in an image and generates information on the face location as probability distribution data. Specifically, the unit generates an expected value and dispersion data N (mₑ, σₑ) relating to the location and direction of the face. Moreover, the unit generates user identification information based on the comparison process with information on the characteristics of users' faces registered in advance and input the information to the audio-image integration processing unit 131. Furthermore, the image event detecting unit 112 detects a face attribute score as the face attribute information from the face area in the image input from the image input unit (camera) 111, for example, by detecting a movement of the mouth area, calculating a score corresponding to the detection results of the movement in the mouth area, specifically a face attribute score in such a way that a high score is given to a case where the extent of the movement in the mouth is determined to be great, and the score is input to the audio-image integration processing unit 131.

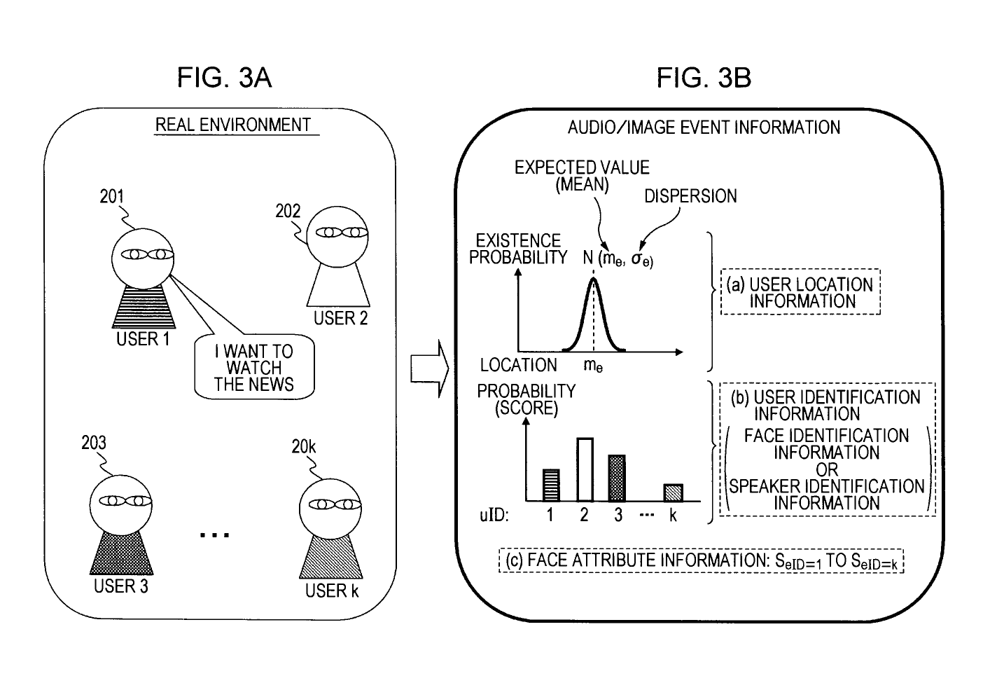

An example of information generated by the audio event detecting unit 122 and the image event detecting unit 112 and input to the audio-image integration processing unit 131 will be described with reference to FIGS. 3A and 3B.

In the configuration of the invention, the image event detecting unit 112 generates and inputs the following data to the audio-image integration processing unit 131:

(Va) An expected value and dispersion data N (mₑ, σₑ) relating to the location and direction of the face;

(Vb) User identification information based on information on the characteristics of a face image; and

(Vc) A score corresponding to the face attributes detected, for example, a face attribute score generated based on a movement in the mouth area.

The audio event detecting unit 122 inputs the following data to the audio-image integration processing unit 131:

(Aa) An expected value and dispersion data N (mₑ, σₑ) relating to the direction of an audio source; and

(Ab) User identification information based on information on the characteristics of a voice.

FIG. 3A shows an example of a real environment where the same camera and microphones are arranged as described with reference to FIG. 1, and there is a plurality of users 1 to k with reference numerals of 201 to 20k. In that environment, when a user speaks, the voice of the user is input through a microphone. In addition, the camera consecutively captures images.

Information generated by the audio event detecting unit 122 and the image event detecting unit 112 and input to the audio-image integration processing unit 131 is largely classified into the following three types:

(a) User location information;

(b) User identification information (face identification information or speaker identification information); and

(c) Face attribute information (face attribute score).

In other words, (a) user location information is integrated data combined with:

(Va) An expected value and dispersion data N (mₑ, σₑ) relating to the location and direction of the face generated by the image event detecting unit 112; and

(Aa) An expected value and dispersion data N (mₑ, σₑ) relating to the direction of an audio source generated by the audio event detecting unit 122.

In addition, (b) user identification information (face identification information or speaker identification information) is integrated data combined with:

(Vb) User identification information based on information on characteristics of a face image generated by the image event detecting unit 112; and

(Ab) user identification information based on information on characteristics of a sound generated by the audio event detecting unit 122.

(c) Face attribute information (face attribute score) corresponds to:

(Vc) A score corresponding to face attributes detected, for example, a face attribute score generated based on a movement in the mouth area generated by the image event detecting unit 112.

The following three pieces of information are generated whenever an event occurs:

(a) User location information;

(b) User identification information (face identification information or speaker identification information); and

(c) Fact attribute information (face attribute score). The audio event detecting unit 122 generates the above (a) user location information and (b) user identification information based on audio information when the audio information is input from the audio input units (microphones) 121a to 121d, and inputs the information to the audio-image integration processing unit 131. The image event detecting unit 112 generates (a) user location information, (b) user identification information, and (c) face attribute information (face attribute score) based on image information input from the image input unit (camera) 111 in a regular frame interval determined in advance, and inputs the information to the audio-image integration processing unit 131. Furthermore, this example shows that the one camera is set as the image input unit (camera) 111, and one camera is set to capture images of the plurality of users, and in this case, (a) user location information and (b) user identification information are generated for each of the plural faces included in one image and the information is input to the audio-image integration processing unit 131.

Description will be provided for a process by the audio event detecting unit 122 that the following information is generated based on the audio information input from the audio input units (microphones) 121a to 121d:

(a) User location information; and

(b) User identification information (speaker identification information).

### [Process of Generating (a) User Location Information by the Audio Event Detecting Unit 122]

The audio event detecting unit 122 generates information for estimating the location of a user, that is, a speaker who speaks a word, analyzed based on audio information input from the audio input units (microphones) 121a to 121d. In other words, the location where the speaker is situated is generated as a Gaussian distribution (normal distribution) data N (mₑ, σₑ) constituted by an expected value (mean) [mₑ] and dispersion information [σₑ].

### [Process of Generating (b) User Identification Information (Speaker Identification Information) by the Audio Event Detecting Unit 122]

The audio event detecting unit 122 estimates who the speaker is based on audio information input from the audio input units (microphones) 121a to 121d by a comparison process with input voices and information on the characteristics of voices of the users 1 to k registered in advance. To be more specific, the probability that the speaker is each of the users 1 to k is calculated. The calculated value is adopted as (b) user identification information (speaker identification information). For example, data set with a probability that the speaker is each of the users is generated by a process in such a way that a user having the characteristics of the audio input closest to the registered characteristics of the voice is assigned with the highest score and a user having the characteristics most different from the registered characteristics is assigned with the lowest score (for example, 0), and the data is adopted as (b) user identification information (speaker identification information).

Next, description will be provided for a process by the image event detecting unit 112 that the following information is generated based on image information input from the image input unit (camera) 111:

(a) User location information;

(b) User identification information (face identification information); and

(c) Face attribute information (face attribute score).

### [Process of Generating (a) User Location Information by the Image Event Detecting Unit 112]

The image event detecting unit 112 generates information for estimating the location of the face for each face included in the image information input from the image input unit (camera) 111. In other words, the location where the face detected from the image is estimated to be present is generated as a Gaussian distribution (normal distribution) data N (mₑ, σₑ) constituted by an expected value (mean) [mₑ] and dispersion information [σₑ].

### [Process of Generating (b) User Identification Information (Face Identification Information) by the Image Event Detecting Unit 112]

The image event detecting unit 112 detects a face included in the image information and estimates whose the face is based on the image information input from the image input unit (camera) 111 by a comparison process with input image information and information on the characteristics of faces of the users 1 to k registered in advance. To be more specific, the probability that the extracted face is of each of the users 1 to k is calculated. The calculated value is adopted as (b) user identification information (face identification information). For example, data set with a probability that the face is of each of the users is generated by a process in such a way that a user having characteristics of the face included in the input image closest to the registered characteristics of the face is assigned with the highest score and a user having the characteristics most different from the registered characteristics is assigned with the lowest score (for example, 0), and the data is adopted as (b) user identification information (face identification information).

[Process of Generating (c) Face Attribute Information (Face Attribute Score) by the Image event Detecting Unit 112]

The image event detecting unit 112 can detect the face area included in the image information based on the image information input from the image input unit (camera) 111 and calculate an attribute score for attributes of each detected face, specifically, the movement in the mouth area of the face, whether the face is smiling or not, whether the face is of a man or a woman, whether the face is of an adult or a child, or the like as described above, but in the present process example, description is provided for calculating and using a score corresponding to the movement in the mouth area of the face included in the image as a face attribute score.

As a process of calculating a score corresponding to the movement in the mouth area of the face, the image event detecting unit 112 detects the left and right end points of the lips from the face image detected from the input image from the image input unit (camera) 111, calculates a difference in luminance by aligning the left and right end points of the lips in the N-th frame and the N+1-th frame, and a threshold process on this difference value is performed as described above. With the process, the mouth movement is detected and a face attribute score which is calculated by giving a high score corresponding to the magnitude of the mouth movement is set.

Furthermore, when a plurality of faces is detected from the captured image of the camera, the image event detecting unit 112 generates the event information corresponding to each face as the individual event for the detected face. In other words, the unit generates event information including the following information to input to the audio-image integration processing unit 131:

(a) User Location Information;

(b) User Identification Information (Face Identification Information); and

(c) Face Attribute Information (Face Attribute Score).

This example shows that one camera is used as the image input unit 111, but images captured by a plurality of cameras may be used, and in that case, the image event detecting unit 112 generates the following information for each face included in each of the images captured by the camera to input to the audio-image integration processing unit 131:

(a) User Location Information;

(b) User Identification Information (Face Identification Information); and

(c) Face Attribute Information (Face Attribute Score).

Next, a process executed by the audio-image integration processing unit 131 will be described. The audio-image integration processing unit 131 sequentially inputs three pieces of information shown in FIG. 3B, which are:

(a) User location information;

(b) User identification information (face identification information or speaker identification information); and

(c) Fact attribute information (face attribute score) from the audio event detecting unit 122 and the image event detecting unit 112 as described above. Various settings of input timing are possible for each piece of information, but for example, the audio event detecting unit 122 can be set to generate each of the information of (a) and (b) as audio event information for inputting when a new sound is to be input, and the image event detecting unit 112 can be set to generate each of the information of (a), (b), and (c) above as image event information for inputting in a unit of regular frame cycle.

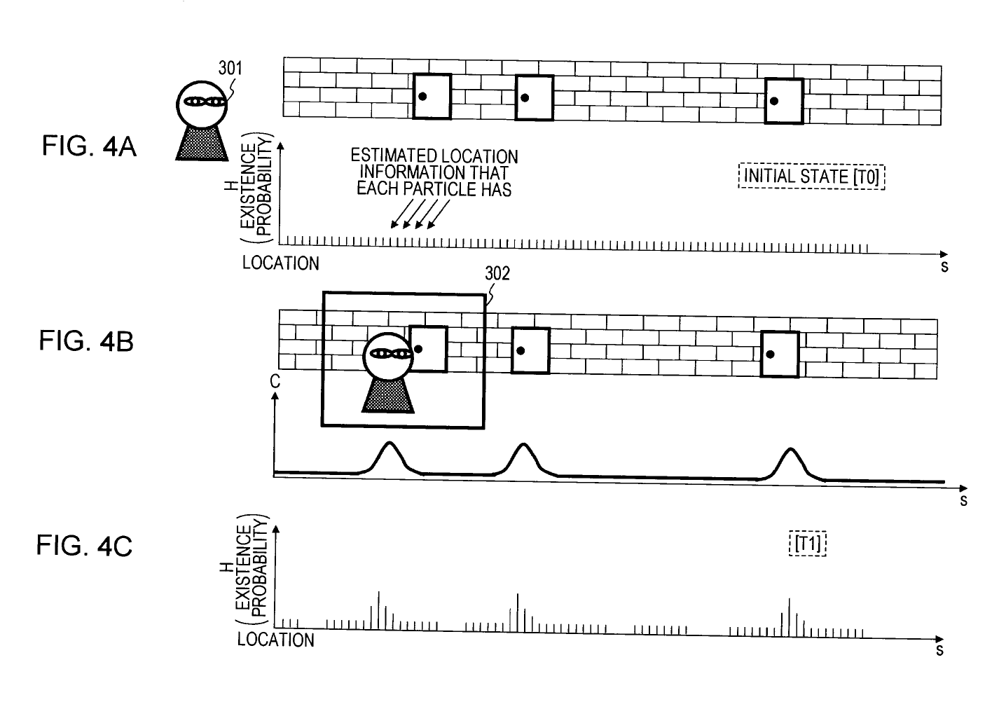

A process executed by the audio-image integration processing unit 131 will be described with reference to FIGS. 4A to 4C and subsequent drawings. The audio-image integration processing unit 131 sets the probability distribution data of hypothesis regarding the user location and identification information, and performs a process by updating the hypothesis based on input information so that only plausible hypothesis remain. As the processing method, a process to which a particle filter is applied is executed.

The process to which the particle filter is applied is performed by setting a large number of particles corresponding to various hypothesis. According to the present example, a large number of particles are set corresponding to hypothesis such as where the users are located and who the users are. In addition to that, a process of increasing the weight of the more plausible particles is performed by the audio event detection unit 122 and the image event detection unit 112, on the basis of the three pieces of input information shown in FIG. 3B, which are:

(a) User location information;

(b) User identification information (face identification information or speaker identification information); and

(c) Fact attribute information (face attribute score).

A basic process example to which the particle filter is applied will be described with reference to FIGS. 4A to 4C. For example, the example of FIGS. 4A to 4C shows a process to estimate the existing location corresponding to a user with the particle filter. The example of FIGS. 4A to 4C is a process to estimate the location of a user 301 in a one dimensional area on a straight line.

An initial hypothesis (H) is a uniform particle distribution data as shown in FIG. 4A. Next, an image data 302 is acquired, and the existence probability distribution data of the user 301 based on the acquired image is acquired as the data of FIG. 4B. The particle distribution data of FIG. 4A is updated and the updated hypothesis probability distribution data of FIG. 4C is obtained based on the probability distribution data based on the acquired image. Such a process is repeatedly executed based on the input information, and more accurate user location information is obtained.

Furthermore, a detailed process which uses a particle filter is disclosed in, for example, [People Tracking with Anonymous and ID-sensors Using Rao-Blackwellised Particle Filters] by D. Schulz, D. Fox, and J. Hightower, Proceedings of the International Joint Conference on Artificial Intelligence (IJCAI-03).

The process example shown in FIGS. 4A and 4C is described as a process example in which only the input information is set as the image data regarding the user existing location, and the respective particles have only the existing location information on the user 301.

On the other hand, on the basis of the following three pieces of information shown in FIG. 3B from the audio event detecting unit 122 and the image event detecting unit 112, in other words, based on input information of:

(a) User location information;

(b) User identification information (face identification information or speaker identification information); and

(c) Face attribute information (face attribute score)

These processes of determining where the plurality of users is located and who the plurality of users is are performed. Therefore, in the process to which the particle filter is applied, the audio-image integration processing unit 131 sets a large number of particles corresponding to hypothesis of where the users are located and who the users are. On the basis of the three pieces of information shown in FIG. 3B from the audio event detecting unit 122 and the image event detecting unit 112, the particle is updated.

A process example of particle update that the audio-image integration processing unit 131 executes by inputting the three pieces of information shown in FIG. 3B, which are:

(a) User location information;

(b) User identification information (face identification information or speaker identification information); and

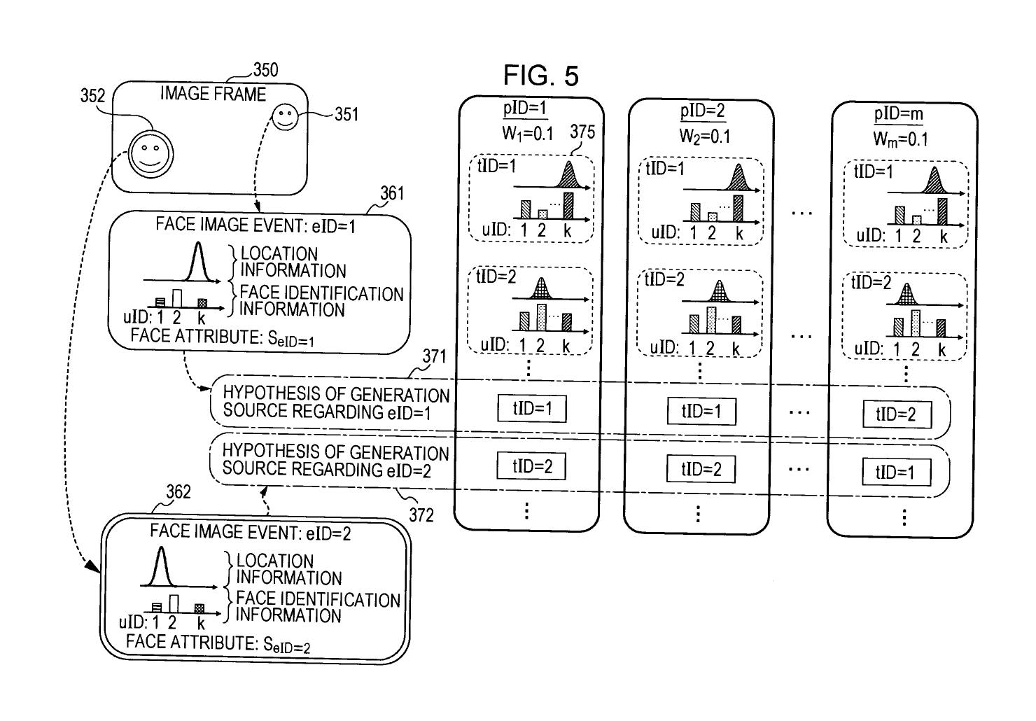

(c) Face attribute information (face attribute score) from the audio event detecting unit 122 and the image event detecting unit 112 will be described with reference to FIG. 5.

The composition of a particle will be described. The audio-image integration processing unit 131 has the previously set number (=m) of particles. They are particles 1 to m shown in FIG. 5. Respective particles are set with particle IDs (pID=1 to m) as identifiers.

Respective particles are set with a plurality of targets of tID=1, 2, . . . , n corresponding to virtual objects. In the present example, a plurality of targets (n number) corresponding to virtual users equal to or higher than the number of people estimated to exist in the real space, for example, are set to each particle. Each of the m number of particles holds data for the number of targets in the units of the target. According to the example illustrated in FIG. 5, one particle includes n targets. The drawing illustrates specific data example only for two targets (tID=1 and 2) out of n targets.

The audio-image integration processing unit 131 performs an updating process for m particles (pID=1 to m) by inputting the event information shown in FIG. 3B from the audio event detecting unit 122 and the image event detecting unit 112, which are:

(a) User location information;

(b) User identification information (face dentification information or speaker identification information); and

(c) Face attribute information (face attribute score [S_{eID}]).

Each of the targets 1 to n included in each of the particles 1 to m set in the audio-image integration processing unit 131 shown in FIG. 5 corresponds to each of the input event information (eID=1 to k) in advance, and according to the correspondence, a selected target corresponding to an input event is updated. To be more specific, for example, such a process is performed that the face image detected in the image event detecting unit 112 is set as the individual event, and the targets are associated with the respective face image events.

The specific updating process will be described. For example, at a predetermined regular frame interval, the image event detecting unit 112 generates (a) user location information, (b) user identification information, and (c) the face attribute information (face attribute score) to input to the audio-image integration processing unit 131 on the basis of the image information input from the image input unit (camera) 111.

At this time, in a case where an image frame 350 shown in FIG. 5 is an event detection target frame, events in accordance with the number of face images included in the image frame is detected. In other words, the events are an event 1 (eID=1) corresponding to a first face image 351 shown in FIG. 5 and an event 2 (eID=2) corresponding to a second face image 352.

The image event detecting unit 112 generates the following information for each of the events (eID=1 and 2) to input to the audio-image integration processing unit 131, which are:

(a) User location information;

(b) User identification information (face identification information or speaker identification information); and

(c) Face attribute information (face attribute score).

In other words, the integrated information is the event corresponding information 361 and 362 shown in FIG. 5.

Each of the targets 1 to n included in the particles 1 to m set in the audio-image integration processing unit 131 is configured to correspond to each of the events (eID=1 to k) in advance, and which target in the respective particles is to be updated is set in advance. Furthermore, correspondence of targets (tID) to the events (eID=1 to k) is set so as to not overlap. In other words, the same number of event generation source hypothesis as that of the obtained events is generated so as to avoid the overlap in the respective particles.

In the example shown in FIG. 5, (1) the particle 1 (pID=1) has the following setting.

The corresponding target of [event ID=1 (eID=1)]=[target ID=1 (tID=1)]

The corresponding target of [event ID=2 (eID=2)]=[target ID=2 (tID=2)]

(2) The particle 2 (pID=2) has the following setting.

$$The corresponding target of [ event ID = 1 ( eID = 1 ) ] = [ target ID = 1 ( tID = 1 ) ]$$

$$The corresponding target of [ event ID = 2 ( eID = 2 ) ] = [ target ID = 2 ( tID = 2 ) ]$$

$$⋮$$

(m) The particle m (pId=m) has the following setting.

The corresponding target of [event ID=1 (eID=1)]=[target ID=2 (tID=2)]

The corresponding target of [event ID=2 (eID=2)]=[target ID=1 (tID=1)]

In this manner, each of the targets 1 to n included in each of the particles 1 to m set in the audio-image integration processing unit 131 is configured to correspond to each of the events (eID=1 to k), and which target included in each particle is to be updated is determined according to each of the event ID. For example, in the particle 1 (pID=1), the event corresponding information 361 of [event ID=1 (eID=1)] shown in FIG. 5 selectively updates only the data of the target ID=1 (tID=1).

Similarly, in the particle 2 (pID=2), the event corresponding information 361 of [event ID=1 (eID=1)] shown in FIG. 5 selectively updates only the data of the target ID=1 (tID=1). In addition, in the particle m (pID=m), the event corresponding information 361 of [event ID=1 (eID=1)]shown in FIG. 5 selectively updates only the data of the target ID=2 (tID=2).

Event generation source hypothesis data 371 and 372 shown in FIG. 5 are event generation source hypothesis data set in the respective particles. The event generation source hypothesis data are set in the respective particles, and the update target corresponding to the event ID is determined in accordance with the setting information.

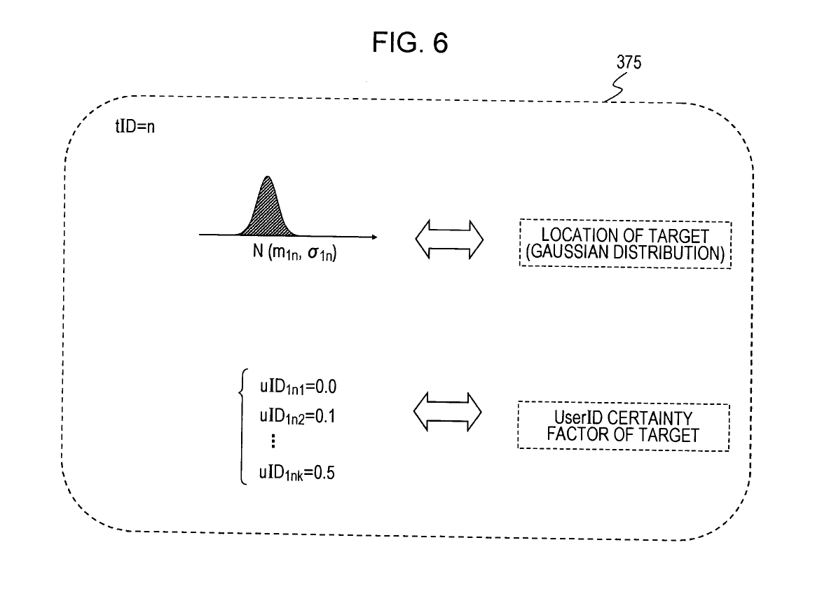

Each of the target data included in each of the particles will be described with reference to FIG. 6. FIG. 6 shows the composition of target data of one target (target ID: tID=n) 375 included in the particle 1 (pID=1) shown in FIG. 5. As shown in FIG. 6, the target data of the target 375 are constituted by the following data, which are:

(a) Probability distribution of existing location corresponding to each of the targets [Gaussian distribution: N (m₁ₙ, σ₁ₙ)]; and

(b) User certainty factor information indicating who the respective targets are (uID)

$${uID}_{1 n 1} = 0.0$$

$$u {ID}_{1 n 2} = 0.1$$

$$⋮$$

$${uID}_{1 nk} = 0.5$$

Furthermore, (1n) of [m₁ₙ, σ₁ₙ] in Gaussian distribution: N (m₁ₙ, σ₁ₙ) shown in (a) indicates a Gaussian distribution as the existence probability distribution corresponding to target ID: tID=n in particle ID: pID=1.

In addition, (1n1) included in [uID₁ₙ₁] in the user certainty factor information (uID) shown in (b) indicates the probability that the user=the user 1 of target ID: tID=n in particle ID: pID=1. In other words, the data of target ID=n indicates that:

$$The probability that the user is the user 1 is 0.0 ;$$

$$The probability that the user is the user 2 is 0.1 ;$$

$$⋮$$

$$The probability that the user is the user k is 0.5 .$$

Returning to FIG. 5, description will be provided for particles set by the audio-image integration processing unit 131. As shown in FIG. 5, the audio-image integration processing unit 131 sets the predetermined number (=m) of particles (pID=1 to m), and each of the particles has target data as follows for each of the targets (tID=1 to n) estimated to exist in the real space:

(a) Probability distribution of existing location corresponding to each of the targets [Gaussian distribution: N (m, σ)]; and

(b) User certainty factor information indicating who the respective targets are (uID).

The audio-image integration processing unit 131 inputs the event information shown in FIG. 3B, that is, the following event information (eID=1, 2 . . . ) from the audio event detecting unit 122 and the image event detecting unit 112, which are:

(a) User location information;

(b) User identification information (face identification information or speaker identification information); and

(c) Face attribute information (face attribute score [S_{eID}]),

and executes updating of targets corresponding to each event set in each of the particles in advance.

Furthermore, the following data included in each of the target data are to be updated, which are:

(a) User location information; and

(b) User Identification information (face identification information or speaker identification information).

The (c) Face attribute information (face attribute score [S_{eID}]) is finally used as the [signal information] indicating the event generation source. If a certain number of events are input, the weight of each particle is updated, and thereby, the weight of the particle which holds the data closest to the information of the real space increases, and the weight of the particle which holds the data not appropriate for the information of the real space decreases. At a stage where a bias is generated and then converged in the weights of the particles as such, the signal information based on the face attribute information (face attribute score), that is, the [signal information] indicating the event generation source, is calculated.

The probability that a specific target y (tID=y) is the generation source of an event (eID=x) is expressed as:

P_{eID=x}(tID=y).

For example, when m particles (pID=1 to m) are set as shown in FIG. 5, and two targets (tID=1, 2) are set to each of the particles, the probability that the first target (tID=1) is the generation source of the first event (eID=1) is P_{eID=1} (tID=1), and the probability that the second target (tID=2) is the generation source of the first event (eID=1) is P_{eID=1} (tID=2). In addition, the probability that the first target (tID=1) is the generation source of the second event (eID=2) is P_{eID=2} (tID=1), and the probability that the second target (tID=2) is the generation source of the second event (eID=2) is P_{eID=2} (tID=2).

The [signal information] indicating the event generation source is the probability that the generation source of an event (eID=x) is a specific target y (tID=y) is expressed as:

P_{eID=x}(tID=y),

and this is equivalent to the ratio of the number of particles (m) set by the audio-image integration processing unit 131 to the number of targets assigned to each of the events. In the example shown in FIG. 5, the following correspondence relationships are established:

P_{eID=1}(tID=1)=[the number of particles for which tID=1 is assigned to the first event (eID=1)/m];

P_{eID=1}(tID=2)=[the number of particles for which tID=2 is assigned to the first event (eID=1)/m];

P_{eID=2}(tID=1)=[the number of particles for which tID=1 is assigned to the second event (eID=2)/m]; and

P_{eID=2}(tID=2)=[the number of particles for which tID=2 is assigned to the second event (eID=2)/m].

The data is finally used as the [signal information] indicating the event generation source.

The probability that the generation source of an event (eID=x) is a specific target y (tID=y) is expressed by P_{eID=x} (tID=y), and this data is also applied to the calculation of the face attribute information included in the target information. In other words, the data is used when the face attribute information S_{tID=1˜n} is calculated. The face attribute information S_{tID=y} is equivalent to the final expected value of the face attribute of a target of target ID=y, that is, a probability value indicating as a speaker.

The audio-image integration processing unit 131 inputs the event information (eID=1, 2, . . . ) from the audio event detecting unit 122 and the image event detecting unit 112, executes the updating of targets corresponding to each event set in each of the particles in advance, and generates the following information to output to the process determining unit 132, which is:

(a) [Target information] including the estimated location information indicating where the plurality of users is, estimated identification information indicating who the users are (estimated uID information), and furthermore, expected values of the face attribute information (S_{tID}), for example, the face attribute expected values indicating that the mouth is moved for speaking; and

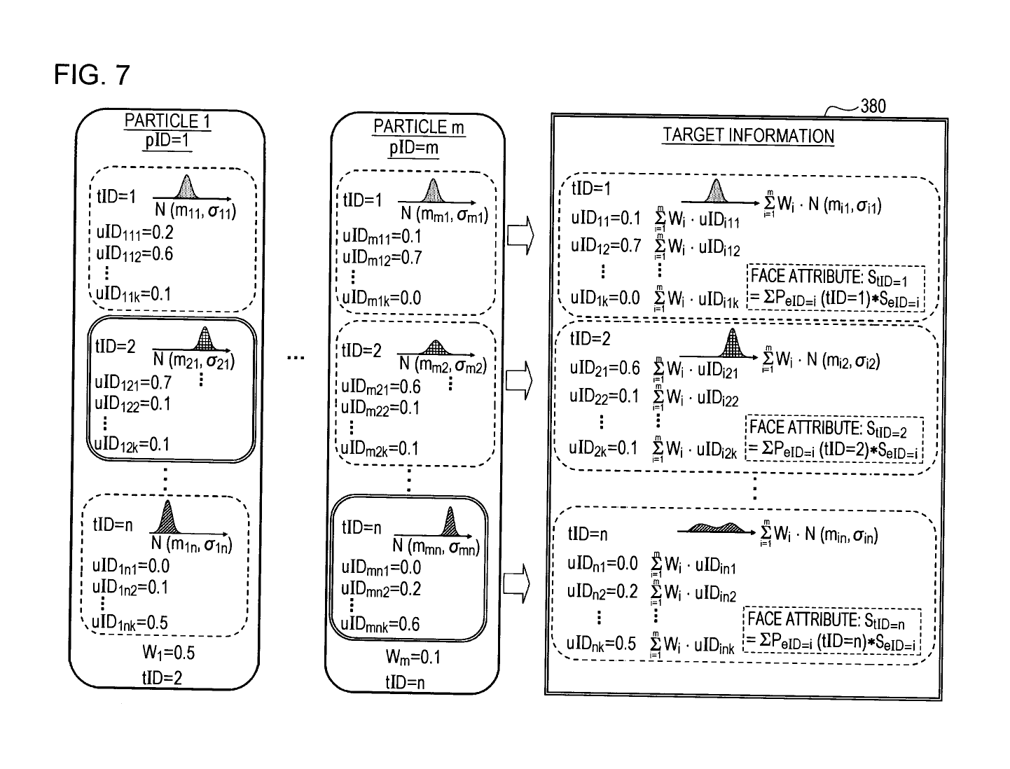

(b) [Signal information] indicating the event generation source of a user, for example, who speaks.

[Target information] is generated as the weighted sum data of the data corresponding to each of the targets (tID=1 to n) included in each of the particles (pID=1 to m) as shown in the target information 380 in the right end of FIG. 7. FIG. 7 shows m particles (pID=1 to m) that the audio-image integration processing unit 131 has and the target information 380 generated from the m particles (pID=1 to m). The weight of each particle will be described later.

The target information 380 includes the following information of targets (tID=1 to n) corresponding to a virtual user set by the audio-image integration processing unit 131 in advance:

(a) Existing location;

(b) Who the user is (which one of uID1 to uIDk); and

(c) Expected value of face attributes (expected value (probability) to be a speaker in this process example).

The (c) expected value of face attributes (expected value (probability) to be a speaker in this process example) of each target is calculated based on the probability for the [signal information] indicating the event generation source as described above, which is P_{eID=x} (tID=y) and a face attribute score S_{eID=i} corresponding to each event. The i represents the event ID.

For example, the expected value of the face attribute of target ID=1: S_{tID=1} is calculated by the formula given below.

S_{tID=1}=Σ_{eID}P_{eID=i}(tID=1)×S_{eID=i}

If the formula is generalized, the expected value of the face attribute of a target: S_{tID} is calculated by the formula given below.

S_{tID}=Σ_{eID}P_{eID=i}(tID)×S_{eID=i} (Formula 1)

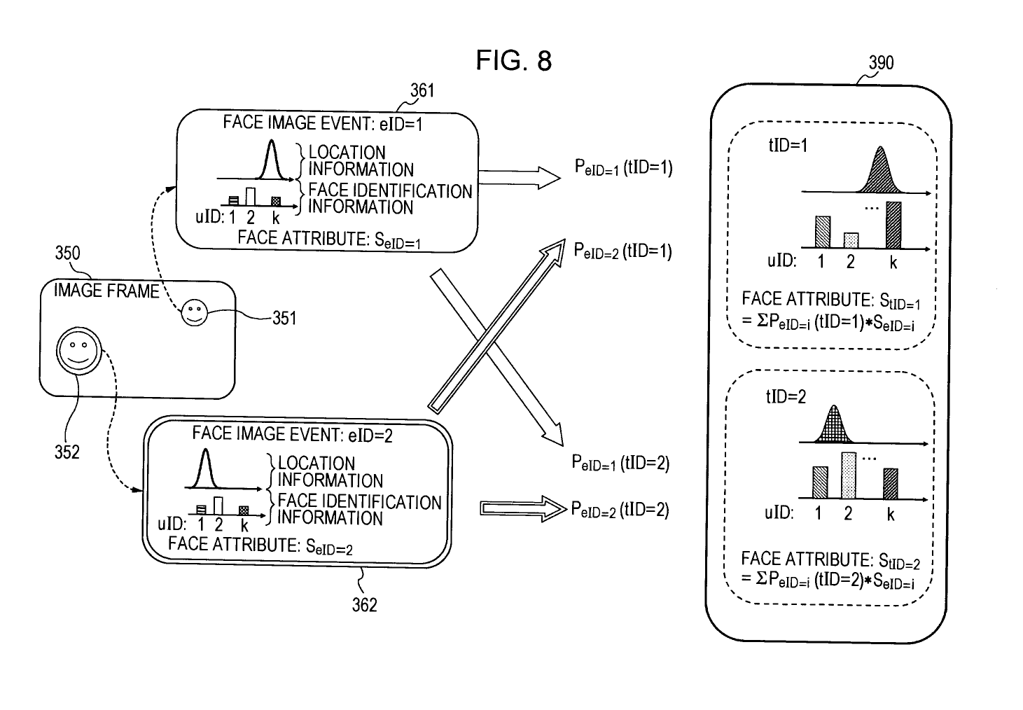

As shown in FIG. 5, when there are two targets in a system, for example, FIG. 8 shows an example of calculating an expected value of face attribute for each target (tID=1 and 2) when two face image events (eID=1 and 2) are input to the audio-image integration processing unit 131 from the image event detecting unit 112 in one image frame.

The data in the right end of FIG. 8 is target information 390 equivalent to the target information 380 shown in FIG. 7, and equivalent to information generated as the weighted sum data of the data corresponding to each target (tID=1 to n) included in each particle (pID=1 to m).

The face attribute of each target in the target information 390 is calculated based on the probability equivalent to the [signal information] indicating the event generation source [P_{eID=x} (tID=y)] as described above and a face attribute score [S_{eID=i}] corresponding to each event. The i represents the event ID.

The expected value of the face attribute of target ID=1: S_{tID=1} is expressed by:

S_{tID=1}=Σ_{eID}P_{eID=i}(tID=1)×S_{eID=i}, and

the expected value of the face attribute of target ID=2: S_{tID=2} is expressed by:

S_{tID=2}=Σ_{eID}P_{eID=i}(tID=2)×S_{eID=i}.

The sum of all targets of the expected value of the face attribute of each target: S_{tID} is [1]. In the process example, expected values of the face attribute: S_{tID} of each target are set from 0 to 1, and a target with a high expected value is determined to have a high probability of being a speaker.

Furthermore, when (face attribute score [S_{eID}]) does not exist in the face image event eID (for example, when mouth movements are not able to be detected even though the face can be detected because the mouth is covered with a hand), a value of prior knowledge [Sₚᵣᵢₒᵣ] is used in the face attribute score [S_{eID}]. Such a configuration can be adopted that when there is a value previously acquired for each target, the value is used as a value of the prior knowledge, or an average value of the face attribute from the face image event obtained offline beforehand is calculated for the use.

The number of targets and the number of face image events in one image frame are not limited to be the same at all times. Since the sum of the probability [P_{eID} (tID)] equivalent to the [signal information] indicating the above-described event generation source is not [1] when the number of targets is higher than that of the face image events, the sum of the expected values for targets is not [1] based on the above-described expected value calculation formula of the face attribute of each target, that is:

S_{tID}=Σ_{eID}P_{eID=i}(tID)×S_{eID} (Formula 1).

Therefore, it is not able to calculate a highly accurate expected value.

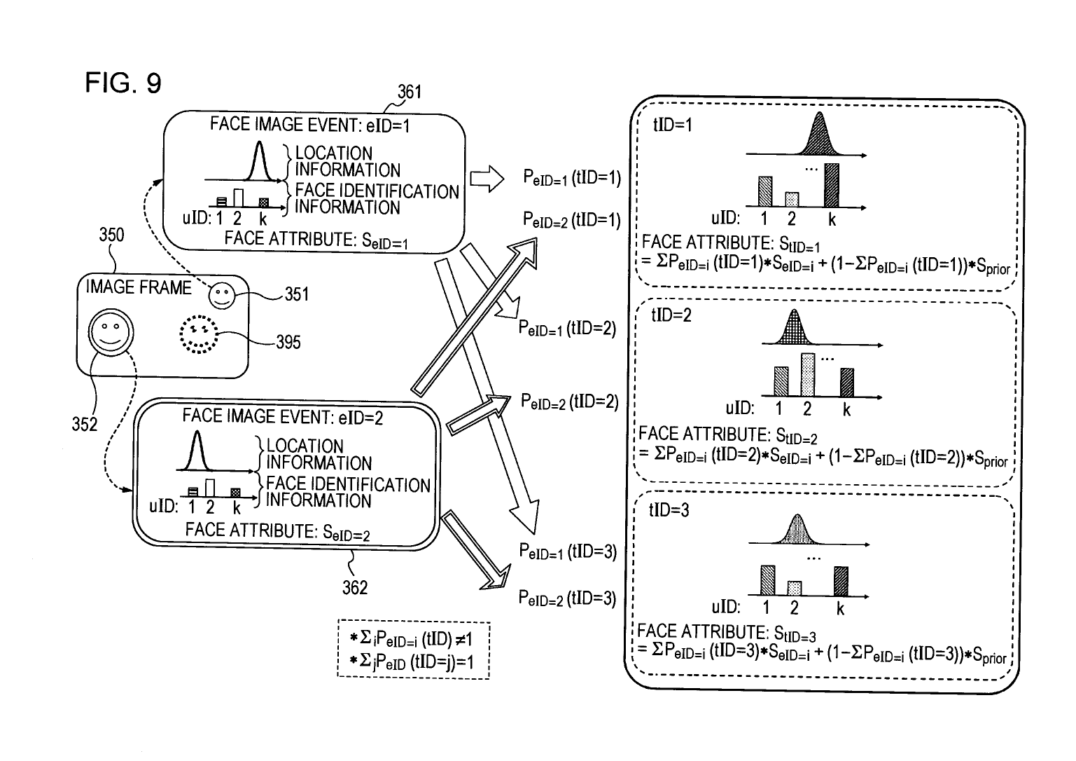

As shown in FIG. 9, since the sum of expected values for targets is not [1] based on the above (Formula 1) when a third face image 395 corresponding to a third event which existed in the previous processing frame in the image frame 350 is not detected, it is not able to calculate a highly accurate expected value. In that case, the expected value calculation formula of the face attribute for targets is modified. In other words, in order to make the sum of the expected values [S_{tID}] of the face attribute for targets [1], the expected value [S_{tID}] of the face event attribute is calculated by the following formula (Formula 2) by using a complement number [1−Σ_{eID}P_{eID} (tID)] and a value of prior knowledge [Sₚᵣᵢₒᵣ].

S_{tID}=Σ_{eID}P_{eID}(tID)×S_{eID}+(1−Σ_{eID}P_{eID}(tID))×Sₚᵣᵢₒᵣ (Formula 2)

FIG. 9 is set with three targets corresponding to events in a system, and illustrates a calculation example of an expected value of the face attribute when only two targets are input from the image event detecting unit 112 to the audio-image integration processing unit 131 as face image events in one image frame.

Calculation is possible for

The expected value of the face attribute for target ID=1: S_{tID=1} with S_{tID=1}=Σ_{eID}P_{eID=1} (tID=1)×S_{eID=i} (1−Σ_{eID}P_{eID} (tID=1))×Sₚᵣᵢₒᵣ,

The expected value of the face attribute for target ID=2: S_{tID=2} with S_{tID=2}=Σ_{eID}P_{eID=i} (tID=2)×S_{eID=i}+(1−Σ_{eID}P_{eID} (tID=2))×Sₚᵣᵢₒᵣ, and

The expected value of the face attribute for target ID=3: S_{tID=3} with S_{tID=3}=Σ_{eID}P_{eID=i} (tID=3)×S_{eID=i}+(1+Σ_{eID}P_{eID} (tID=3))×Sₚᵣᵢₒᵣ.

To the contrary, when the number of targets is lower than that of the face image events, a target is generated so that the number is the same as that of events, and the expected value [S_{tID=1}] of the face attribute for each target is calculated by being applied with the above-described (Formula 1).

Furthermore, in this process example, the face attribute is described as data indicating the expected values of the face attribute based on scores corresponding to mouth movements, that is, values that respective targets are expected to be a speaker. As described above, however, a face attribute score is possibly calculated as a score based on smiling, age, or the like, and the expected value of the face attribute in that case is calculated as data for the attribute according to the score.

In addition, according to the subject of the latter part [2. Regarding speaker specification process in association with a score (AVSR score) calculation process by voice- and image-based speech recognition], a score by speech recognition (AVSR score) can also be calculated, and the expected value of the face attribute in this case is calculated as data for the attribute according to a score by the speech recognition.

In accordance with the updating of particles, the target information is successively updated, and for example, when the users 1 to k do not move in the real environment, each of the users 1 to k converges as data corresponding to k targets selected from n targets (tID=1 to n).

For example, the user certainty factor information (uID) included in the data of the uppermost target 1 (tID=1) of the target information 380 shown in FIG. 7 has the highest probability for the user 2 (uID₁₂=0.7). Therefore, the data of the target 1 (tID=1) is estimated to correspond to the user 2. Furthermore, (12) in (uID₁₂) of data [uID₁₂=0.7] indicating the user certainty factor information (uID) is the probability corresponding to the user certainty factor information (uID) of the user 2 for the target ID=1.

The data of the uppermost target 1 (tID=1) of the target information 380 has the highest probability of being the user 2, and the existing location of the user 2 is estimated to be within the range of existence probability distribution data included in the data of the uppermost target 1 (tID=1) of the target information 380.

As such, the target information 380 indicates the following information for each of the targets (tID=1 to n) initially set as a virtual object (virtual user):

(a) Existing location;

(b) Who the user is (which one of uID1 to uIDk); and

(c) Face attribute expected value (expected value (probability) of being a speaker in this process example). Therefore, each information of k targets out of targets (tID=1 to n) converges so as to correspond to users 1 to k when the users do not move.

As described before, the audio-image integration processing unit 131 executes an updating process for particles based on input information and generates the following information to input to the process determining unit 132.

(a) [Target information] as information for estimating where each of the plurality users is and who the users are

(b) [Signal information] indicating event generation source such as a user, for example, who speaks words

As such, the audio-image integration processing unit 131 executes a particle filtering process which is applied with a plurality of particles set with a plurality of target data corresponding to virtual users, and generates analysis information including location information of a user existing in the real space. In other words, each of the target data set in particles is set to correspond to each of the events input from an event detecting unit and the target data corresponding to events selected from each of the particles is updated according to an input event identifier.

In addition, the audio-image integration processing unit 131 calculates the likelihood between the event generation source hypothesis targets set in the respective particles and the event information input from the event detection unit, and sets a value in accordance with the magnitude of the likelihood in the respective particles as the particle weight. Then, the audio-image integration processing unit 131 executes a re-sampling process of re-selecting the particle with the large particle weight by priority and performs the particle updating process. This process will be described below. Furthermore, regarding the targets set in the respective particles, the updating process is executed while taking the elapsed time into consideration. In addition, in accordance with the number of the event generation source hypothesis targets set in the respective particles, the signal information is generated as the probability value of the event generation source.

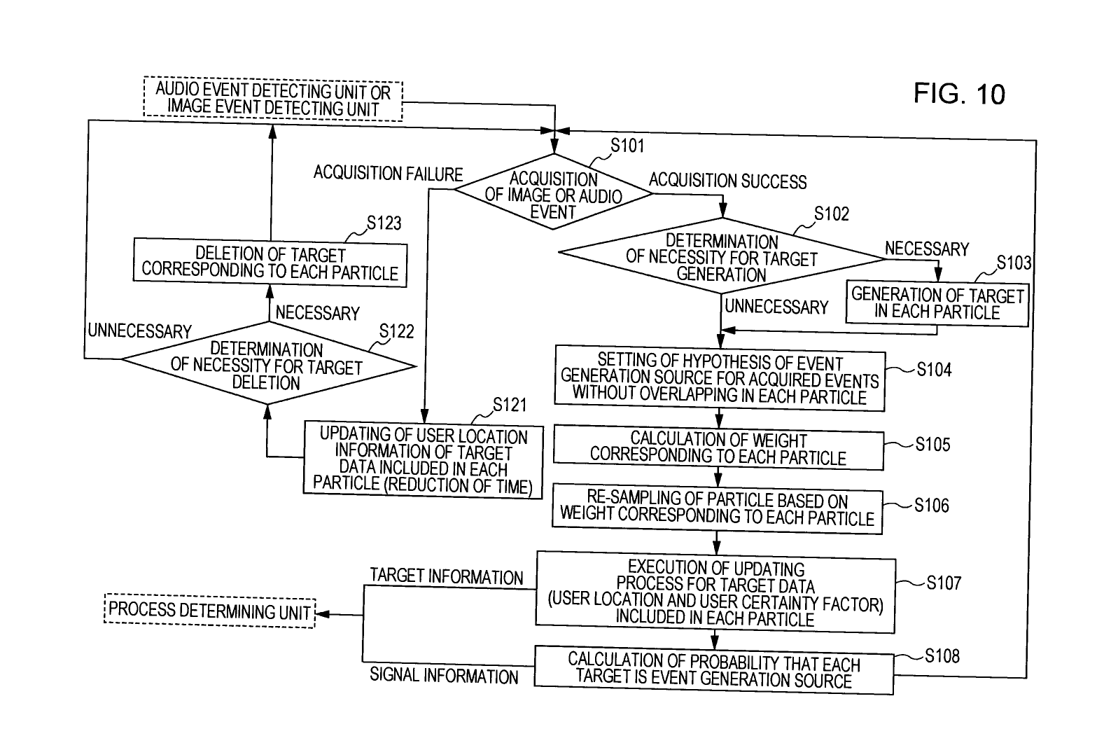

With reference to the flowchart shown in FIG. 10, a process sequence will be described where the audio-image integration processing unit 131 inputs the event information shown in FIG. 3B, in other words, the user location information, the user identification information (face identification information or speaker identification information) from the audio event detecting unit 122 and the image event detecting unit 112. By inputting such event information, the audio-image integration processing unit 131 generates:

(a) the [Target information] as information for estimating where each of the plurality of users is and who the users are and

(b) the [Signal information] indicating event generation source such as a user, for example, who speaks words to output to the process determining unit 132.

First in Step S101, the audio-image integration processing unit 131 inputs the event information as follows from the audio event detecting unit 122 and the image event detecting unit 112, which are:

(a) User location information;

(b) User identification information (face identification information or speaker identification information); and

(c) Face attribute information (face attribute score).

When acquisition of the event information succeeds, the process advances to Step S102, and when acquisition of the event information fails, the process advances to Step S121. The process in Step S121 will be described later.

When acquisition of the event information succeeds, the audio-image integration processing unit 131 performs an updating process of particles based on the input information in Step S102 and subsequent steps. Before the particle updating process, first, in step S102, it is determined as to whether or not the new target setting is necessary with respect to the respective particles. In the configuration according to the embodiment of the invention, as described above with reference to FIG. 5, each of the targets 1 to n included in each of the particles 1 to m set by the audio-image integration processing unit 131 corresponds to respective pieces of input event information (eID=1 to k) in advance. According to the correspondence, the updating is configured to be executed on the selected target corresponding to the input event.

Therefore, for example, in a case where the number of events input from the image event detecting unit 112 is higher than the number of targets, a new target setting is necessary. To be more specific, for example, the case corresponds to a case where a face which has not existed thus far appears in the image frame 350 shown in FIG. 5 or the like. In such a case, the process advances to step S103, and the new target is set in the respective particles. This target is set as a target updated while corresponding to a new event.

Next, in step S104, a hypothesis of the event generation source is set for m particles (pID=1 to m) of the respective particles 1 to m set by the audio-image integration processing unit 131. With respect to an event generation source, for example, a user who speaks is the event generation source for an audio event and a user who has the extracted face is the event generation source for an image event.

As described with reference to FIG. 5 above, a hypothesis setting process of the invention is set such that each of the targets 1 to n included in each of the particles 1 to m corresponds to each piece of input event information (eID=1 to k).

In other words, as described with reference to FIG. 5 before, each of the targets 1 to n included in each of the particles 1 to m is set to correspond to each of the events (eID=1 to k), and to update which target included in each of the particles. In this manner, the same number of event generation source hypothesis as the obtained events are generated so as to avoid overlapping the respective particles. It should be noted that in an initial stage, for example, such a setting may be adopted that the respective events are evenly distributed. Since the number of particles (=m) is set higher than the number of targets (=n), a plurality of particles are set as the particle having such correspondence of the same event ID to target ID. For example, in a case where the number of targets (=n) is 10, such a process of setting the number of particles (=m) to be about 100 to 1000 or the like is performed.

After the hypothesis setting in Step S104, the process advances to Step S105. In Step S105, a weight corresponding to the respective particles, that is, a particle weight [W_{pID}], is calculated. In the initial stage, the particle weight [W_{pID}] is set to a uniform value for each of the particles, but is updated according to each event input.

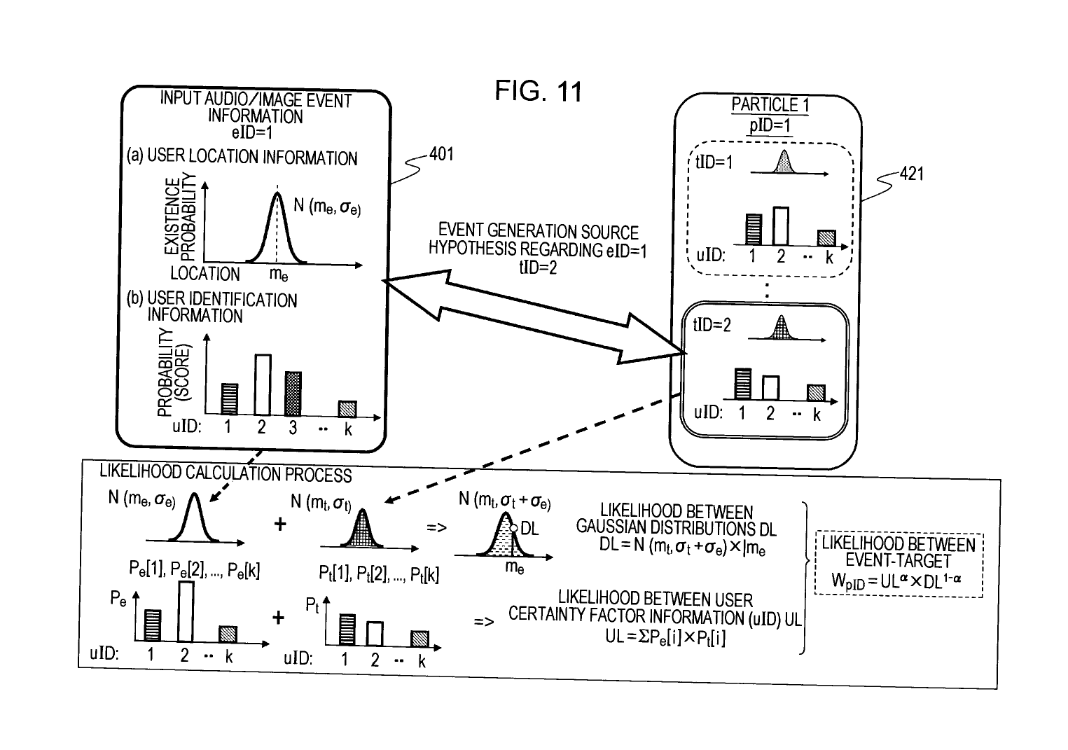

With reference to FIG. 11, a calculation process of the particle weight [W_{pID}] will be described in detail. The particle weight [W_{pID}] is equivalent to the index of correctness of the hypothesis of respective particles which generates the hypothesis target of an event generation source. The particle weight [W_{pID}] is calculated as the likelihood between an event and a target which is the similarity of the input event of the event generation source corresponding to each of the plurality of targets set in each of m particles (pID=1 to m).

FIG. 11 shows the event information 401 corresponding to one event (eID=1) that the audio-image integration processing unit 131 inputs from the audio event detecting unit 122 and the image event detecting unit 112 and one particle 421 that the audio-image integration processing unit 131 holds. The target (tID=2) of the particle 421 is the target corresponding to the event (eID=1).

The lower part of FIG. 11 shows a calculation process example of the likelihood between an event and a target. The particle weight [W_{pID}] is calculated as a value corresponding to the sum of the likelihood between an event and a target as a similarity index between an event and a target calculated in each particle.

The likelihood calculating process shown in the lower part of FIG. 11 shows an example of calculating the following likelihood individually.

(a) Likelihood between the Gaussian distributions [DL] functioning as the similarity data between the event and the target data for the user location information

(b) Likelihood between the user certainty factor information (uID) [UL] functioning as the similarity data between the event and the target data for the user identification information (face identification information or speaker identification information)

Calculation of the (a) likelihood between the Gaussian distributions [DL] functioning as the similarity data between the event and the target data for the user location information is processed as below.

In the input event information, with the definition that the Gaussian distribution corresponding to the user location information is N (mₑ, σₑ) and the Gaussian distribution corresponding to the user location information for a hypothesis target selected from a particle is N (mₜ, σₜ), the likelihood between the Gaussian distributions [DL]is calculated by the following formula.

DL=N(mₜ,σₜ+σₑ)×|mₑ

The above formula is for calculating a value of the location of x=mₑ in a Gaussian distribution in which the dispersion is σₜ+σₑ and the center is mₜ.

Calculation of the (b) likelihood between the user certainty factor information (uID) [UL] functioning as the similarity data between the event and the target data for the user identification information (face identification information or speaker identification information) is processed as below.

In the input event information, a value (score) of the certainty factor of each user 1 to k in the user certainty factor information (uID) is Pe[i]. i is a variable corresponding to the user identifiers 1 to k. With the definition that a value (score) the of certainty factor of each user 1 to k in the user certainty factor information (uID) of a hypothesis target selected from a particle is Pt[i], the likelihood between the user certainty factor information (uID) [UL] is calculated by the following formula.

UL=ΣPₑ[i]×Pₜ[i]

The above formula is for obtaining the sum of the product of a value (score) of each corresponding user certainty factor included in the user certainty factor information (uID) for two targets, and the value referred to as the likelihood between the user certainty factor information (uID) [UL].

A particle weight [W_{pID}] uses two likelihoods, which are the likelihood between the Gaussian distributions [DL] and the likelihood between the user certainty factor information (uID) [UL], and is calculated by the following formula using a weight α (α=0 to 1).

Particle weight [W_{pID}]=ΣₙUL^{α}×DL^{1-α}

In the formula, n is the number of event corresponding targets included in a particle. With the above formula, a particle weight [W_{pID}] is calculated. Wherein, α is 0 to 1. The particle weight [W_{pID}] is calculated for each of the particles respectively.

Furthermore, the weight [α] applied to the calculation of the particle weight [W_{pID}] may be a value fixed in advance, or may be set to change the value according to an input event. For example, when the input event is an image, if the detection of the face succeeds, the location information is acquired, but if the identification of the face is failed, the configuration may be possible such that α is set to 0, and the particle weight [W_{pID}] is calculated by relying only on the likelihood between the Gaussian distributions [DL] with the likelihood between the user certainty factor information (uID) [UL] of 1. In addition, when the input event is a voice, if identification of the speaker succeeds, the speaker information is acquired, but the acquisition of the location information is failed, the configuration may be possible such that α is set to 0, and the particle weight [W_{pID}] is calculated by relying only on the likelihood between the user certainty factor information (uID) [UL] with the likelihood between the Gaussian distributions [DL] of 1.

Calculation of the weight [W_{pID}] corresponding to each particle in Step S105 in the flow of FIG. 10 is executed as a process described with reference to FIG. 11. Next, in Step S106, the particle re-sampling process is executed based on the particle weight [W_{pID}] set in Step S105.

The particle re-sampling process is executed as a process to make the choice of a particle according to the particle weight [W_{pID}] from m particles. To be more specific, when the number of particles (=m) is 5, for example, the particle weight is calculated as below.

Particle 1: particle weight [W_{pID}]=0.40

Particle 2: particle weight [W_{pID}]=0.10

Particle 3: particle weight [W_{pID}]=0.25

Particle 4: particle weight [W_{pID}]=0.05

Particle 5: particle weight [W_{pID}]=0.20

When the particle weight is set as above, the particle 1 is re-sampled with the probability of 40%, and the particle 2 is re-sampled with the probability of 10%. Furthermore, in reality, the number m is a large number such as between 100 and 1000, and the result of re-sampling is constituted by the particles at a distribution ratio in accordance with the weight of the particle.

With the process, more particles with greater particle weight [W_{pID}] remain. In addition, the sum of the particles [m] does not change after the re-sampling. Moreover, each particle weight [W_{pID}] is reset after the re-sampling and the process is repeated from Step S101 according to the input of a new event.

In Step S107, updating of the target data (user location and user certainty factor) included in each particle is executed. As described before with reference to FIG. 7, each target is constituted by the following data.

(a) User location: probability distribution of existing location corresponding to each target [Gaussian distribution: N (mₜ, σₜ)]

(b) User certainty factor: probability value of being a user from 1 to k as user certainty factor information (uID) indicating who the target is: Pt[i](i=1 to k)

In other words,

$$u {ID}_{t 1} = Pt [ 1 ]$$

$$u {ID}_{t 2} = Pt [ 2 ]$$

$$⋮$$

$$u {ID}_{tk} = Pt [ k ]$$

(c) Expected value of the face attribute (expected value (probability) of being a speaker in this process example)

The (c) expected value of the face attribute (the expected value (probability) of being a speaker in this process example) is calculated based on a face attribute score S_{eID=1} corresponding to each event and the probability shown below equivalent to the [signal information] indicating an event generation source as described above. In the face attribute score, i is an event ID.

P_{eID=x}(tID=y)

For example, the expected value of the face attribute of target ID=1: S_{tID=1} is calculated by the following formula.

S_{tID=1}=Σ_{eID}P_{eID=i}(tID=1)×S_{eID=i}

If the formula is generalized, the expected value of the face attribute of a target S_{tID} is calculated by the following formula.

S_{tID}=Σ_{eID}P_{eID=i}(tID)×S_{eID} (Formula 1)

Furthermore, when the number of targets is greater than the number of face image events, in order to make the sum of the expected values [S_{tID}] of the face attribute for each target [1], the expected value [S_{tID}] of the face event attribute is calculated by the following formula (Formula 2) by using a complement number [1−Σ_{eID}P_{eID} (tID)] and a value of prior knowledge [Sₚᵣᵢₒᵣ]

S_{tID}=Σ_{eID}P_{eID}(tID)×S_{eID}+(1−Σ_{eID}P_{eID}(tID))×Sₚᵣᵢₒᵣ (Formula 2)

Updating of the target data in Step S107 is executed for each of the (a) user location, the (b) user certainty factor, and (c) an expected value of the face attribute (the expected value (probability) of being a speaker in this process example). First, an updating process of the (a) user location will be described.

Updating of the user location is executed with the following two stages of updating processes.

(a1) Updating process for all targets of all particles

(a2) Updating process for a hypothesis target of an event generation source set in each particle

The (a1) updating process for all targets of all particles is executed for targets selected as a hypothesis target of an event generation source and other targets. The process is executed based on the supposition that the dispersion of user locations expands according to elapsed time, and updated by using a Kalman Filter with the elapsed time from the previous updating process and the location information of an event.

Hereinbelow, an example of an updating process in a case where the location information is one-dimension will be described. First, the elapsed time from the previous updating process is [dt], and the predicted distribution of user locations for all targets after dt is calculated. In other words, updating is performed as follows for the expected value (mean):[mₜ] and the dispersion [σₜ] of Gaussian distribution: N (mₜ, σₜ) as the distribution information of the user location.

mₜ=mₜ+xc×dt

σₜ²=σₜ²+σc²×dt

### Wherein,

mₜ: predicted expected value (predicted state);

σₜ²: predicted covariance (predicted estimate covariance);

xc: movement information (control model); and

σc²: noise (process noise).

Furthermore, when the process is performed under a condition that a user does not move, the updating process can be performed with xc=0.

With the above calculation process, the Gaussian distribution: N (mₜ, σₜ) as user location information included in all targets is updated.

Next, (a2) the updating process for a hypothesis target of an event generation source set in each particle will be described.

Updating is performed for a target selected according to the hypothesis of an event generation source set in Step S103. As described before with reference to FIG. 5, each of the targets 1 to n included in each of the particles 1 to m is set as a target corresponding to each of the events (eID=1 to k).

In other words, which target included in each particle is to be updated is set in advance according to an event ID (eID), only a target corresponding to an input event is updated according to the setting. For example, with the event corresponding information 361 of [event ID=1 (eID=1)] shown in FIG. 5, only the data of target ID=1 (tID=1) are selectively updated in the particle 1 (pID=1).

In the updating process according to the hypothesis of the event generation source, a target corresponding to an event as above is updated. The updating process is performed by using Gaussian distribution: N (mₑ, σₑ) indicating the user location included in the event information input from the audio event detecting unit 122 and the image event detecting unit 112.

For example, the updating process is performed as below with:

K: Kalman Gain;

mₑ: Observed value included in input event information: N (mₑ, σₑ) (observed state); and

σₑ²: Observed value included in input event information: N (mₑ, σₑ) (observed covariance).

K=σₜ²/(σₜ²+σₑ²)

mₜ=mₜ+K(xc−mₜ)

σₜ²=(1−K)σₜ²

Next, (b) the updating process of the user certainty factor to be executed as an updating process of the target data will be described. In addition to the above user location information, the target data includes a probability value (score): Pt[i] (i=1 to k) of being a user from 1 to k as the user certainty factor information (uID) indicating who the target is. In Step S107, the updating process is performed for the user certainty factor information (uID).

The user certainty factor information (uID): Pt[i] (i=1 to k) of a target included in each particle is updated by a posterior probability for all registered users and the user certainty factor information (uID): Pt[i] (i=1 to k) included in the event information input from the audio event detecting unit 122 and the image event detecting unit 112 with application of an update rate [β] having a value in the range of 0 to 1 set in advance.

Update of the user certainty factor information (uID): Pt[i] (i=1 to k) of a target is executed by the following formula.

Pt[i]=(1=β)×Pt[i]+β*Pe[i]

Wherein, i is 1 to k and p is 0 to 1. Furthermore, the update rate [β] is a value in the range of 0 to 1 set in advance.

In Step S107, each target is constituted by the following data included in the updated target data, which are

(a) User location: probability distribution of existing location corresponding to each target [Gaussian distribution: N (mₜ, σₜ)]

(b) User certainty factor: probability value (score) of being a user from 1 to k as the user certainty factor information (uID) indicating who the target is: Pt[i](i=1 to k)

In other words,

$$u {ID}_{t 1} = Pt [ 1 ]$$

$$u {ID}_{t 2} = Pt [ 2 ]$$

$$⋮$$

$$u {ID}_{tk} = Pt [ k ]$$

(c) Expected value of the face attribute (expected value (probability) of being a speaker in this process example)

Target information is generated based on the data and each particle weight [W_{pID}] and output to the process determining unit 132.

Furthermore, the target information is generated as the weighted sum data of the data corresponding to each target (tID=1 to n) included in each particle (pID=1 to m). The information is the data shown in the target information 380 in the right end of FIG. 7. The target information is generated as information including the following information of each target (tID=1 to n).

(a) User location information

(b) User certainty factor information

(c) Expected value of face attribute (expected value (probability) of being a speaker in this process example)

For example, the user location information in the target information corresponding to a target (tID=1) is expressed by the following formula.

$${\sum }_{i = 1}^{m} {W}_{i} \cdot N ( {m}_{i 1} , {σ}_{i 1} )$$

Wherein, Wᵢ indicates a particle weight [W_{pID}].

In addition, the user certainty factor information in the target information corresponding to a target (tID=1) is expressed by the following formula.

$${\sum }_{i = 1}^{m} {W}_{i} \cdot u {ID}_{i 11}$$

$${\sum }_{i = 1}^{m} {W}_{i} \cdot u {ID}_{i 12}$$

$$⋮$$

$${\sum }_{i = 1}^{m} {W}_{i} \cdot u {ID}_{i 1 k}$$

Wherein, Wᵢ indicates a particle weight [W_{pID}].

In addition, the expected value of the face attribute (the expected value (probability) of being a speaker in this process example) in the target information corresponding to a target (tID=1) is expressed by the following formula.

S_{tID=1}=Σ_{eID}P_{eID=i}(tID=1)×S_{eID=i}, or

S_{tID=1}=Σ_{eID}P_{eID=i}(tID=1)×S_{eID=i}+(1−Σ_{eID}P_{eID}(tID=1))×Sₚᵣᵢₒᵣ

The audio-image integration processing unit 131 calculates the target information for each of n targets (tID=1 to n) and outputs the calculated target information to the process determining unit 132.

Next, a process in Step S108 of the flow shown in FIG. 10 will be described. The audio-image integration processing unit 131 calculates the probability that each of n targets (tID=1 to n) is an event generation source in Step S108, and outputs the probability to the process determining unit 132 as signal information.

As described before, the [signal information] indicating an event generation source is data indicating who spoke, in other words, who the [speaker] is with respect to an audio event, and indicating whose the face included in the image is, in other words, whether the face is the [speaker] with respect to an image event.

The audio-image integration processing unit 131 calculates the probability that each target is an event generation source based on the number of hypothesis targets of an event generation source set in each particle. In other words, the probability that each of the targets (tID=1 to n) is the event generation source is [P(tID=i)]. Wherein, i is 1 to n. For example, as described before, the probability that the generation source of an event (eID=x) is a specific target y (tID=y) is expressed by

P_{eID=x}(tID=y).

This is equivalent to the ratio of the number of particles (=m) set in the audio-image integration processing unit 131 to the number of targets assigned to each of the events. In the example shown in FIG. 5, the following correspondence relationships are established:

P_{eID=1}(tID=1)=[the number of particles for which tID=1 is assigned to the first event (eID=1)/(m)];

P_{eID=1}(tID=2)=[the number of particles for which tID=2 is assigned to the first event (eID=1)/(m)];

P_{eID=2}(tID=1)=[the number of particles for which tID=1 is assigned to the second event (eID=2)/(m)]; and

P_{eID=2}(tID=2)=[the number of particles for which tID=2 is assigned to the second event (eID=2)/(m)].

The data is output to the process determining unit 132 as [signal information] indicating the event generation source.

When the process in Step S108 ends, the process returns to Step S101, and inputting of the event information from the audio event detecting unit 122 and the image event detecting unit 112 is shifted to a standby state.

Hereinabove, Steps S101 to S108 of the flow shown in FIG. 10 have been described. In Step S101, when the audio-image integration processing unit 131 fails to acquire the event information shown in FIG. 3B from the audio event detecting unit 122 and the image event detecting unit 112, data constituting the targets included in each particle are updated in Step S121. This update is a process taking changes of the user location according to the time elapsed into consideration.

The target updating process is the same process as the (a1) updating process for all targets of all particles in the previous description of Step S107, executed based on the supposition that the dispersion of user locations expands according to elapsed time, and updated by the elapsed time from the previous updating process and location information of an event by using a Kalman Filter.

An example of the updating process in a case where the location information is one dimension will be described. First, elapsed time from the previous updating process is [dt], and the predicted distribution of user locations for all targets after dt is calculated. In other words, updating is performed as follows for the expected value (mean):[mₜ] and dispersion [σₜ] of the Gaussian distribution: N (mₜ, σₜ) as the distribution information of user locations.

mₜ=mₜ+xc×dt

σₜ²=σₜ²+σc²×dt

### Wherein,

mₜ: predicted expected value (predicted state);

σₜ²: predicted covariance (predicted estimate covariance);

xc: movement information (control model); and

σc²: noise (process noise).

Furthermore, when the process is performed under a condition where a user does not move, an updating process can be performed with xc=0.

With the above calculation process, the Gaussian distribution: N (mₜ, σₜ) as the user location information included in all targets is updated.

Furthermore, the user certainty factor information (uID) included in the target of each particle is not updated as long as the posterior probability for all registered users of an event or a score [Pe] from event information is not acquired.

After the process in Step S121 ends, it is determined whether a target is necessary to be deleted in Step S122, and the target is deleted depending on the necessity in Step S123. Deletion of the target is executed as a process of deleting data in which a particular user location is not likely to be obtained, for example, in a case where the peak is not detected in the user location information included in the target or the like. In the case where such a target does not exist, the flow returns to Step S101 after the process in steps S122 and S123 where the deletion process is not necessary. The state is shifted to the standby state for the input of the event information from the audio event detecting unit 122 and the image event detecting unit 112.

Hereinabove, the process executed by the audio-image integration processing unit 131 has been described with reference to FIG. 10. The audio-image integration processing unit 131 repeatedly executes the process according to the flow shown in FIG. 10 for every input of event information from the audio event detecting unit 122 and the image event detecting unit 112. With the repeated process, a particle weight with which a target with higher reliability is set as a hypothesis target gets greater, and particles with greater weight remains by the re-sampling process based on the particle weight. As a result, data with higher reliability similar to the event information input from the audio event detecting unit 122 and the image event detecting unit 112 remain, and thereby, the following information with higher reliability is finally generated to be output to the process determining unit 132.

(a) [Target information] as information for estimating where the plurality of users are and who the users are

(b) [Signal information] indicating an event generation source such as a user who speaks, for example

[2. Regarding a Speaker Specification Process in Association with a Score (AVSR Score) Calculation Process by Voice- and Image-Based Speech Recognition]

In the process of the above-described subject no. 1 <1. Regarding Outline of User Location and User Identification Process by Particle Filtering based on Audio and Image Event Detection Information>, the face attribute information (face attribute score) is generated in order to specify a speaker.

In other words, the image event detecting unit 112 provided in the information processing device shown in FIG. 2 calculates a score according to the extent of the mouth movement in the face included in an input image, and a speaker is specified by using the score. However, as briefly described before, there is a problem in that the speech of a user who is making demand to the system is difficult to be specified in the process of calculating a score based on the extent of the mouth movement because users who chew gum, speak irrelevant words to the system, or give irrelevant mouth movements are not able to be distinguished.

As a method to solve the problem, a configuration will be described hereinbelow, in which a speaker is specified by calculating a score according to the correspondence relationship between a movement in the mouth area of the face included in an image and speech recognition.

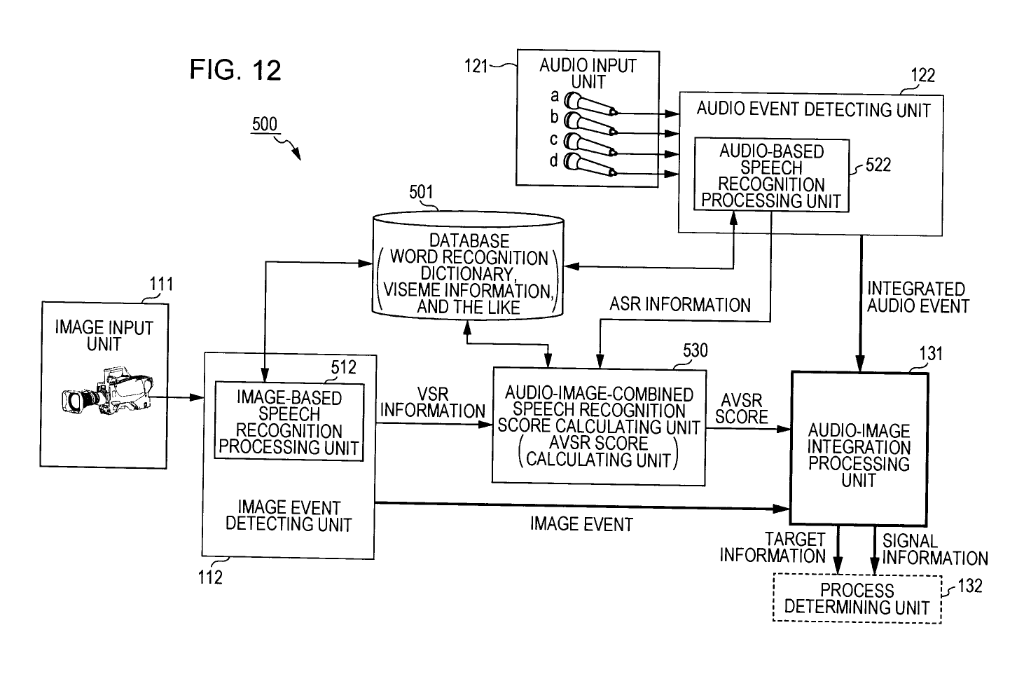

FIG. 12 is a diagram showing a composition example of an information processing device 500 performing the above process. The information processing device 500 shown in FIG. 12 includes an image input unit (camera) 111 as an input device, and a plurality of audio input units (microphones) 121a to 121d. Image information is input from the image input unit (camera) 111, audio information is input from the audio input units (microphones) 121, and analysis is performed based on the input information. Each of the plurality of audio input units (microphones) 121a to 121d is arranged in various locations as shown in FIG. 1 described above.

The image event detecting unit 112, the audio event detecting unit 122, the audio-image integration processing unit 131, and the process determining unit 132 of the information processing device 500 shown in FIG. 12 basically have the same corresponding composition and perform the same processes as the information processing device 100 shown in FIG. 2.

In other words, the audio event detecting unit 122 analyzes the audio information input from the plurality of audio input units (microphones) 121a to 121d arranged in a plurality of different positions and generates the location information of a voice generation source as the probability distribution data. To be more specific, the unit generates an expected value and dispersion data N (mₑ, σₑ) pertaining to the direction of the audio source. In addition, the unit generates the user identification information based on a comparison process with voice characteristic information of users registered in advance.

The image event detecting unit 112 analyzes the image information input from the image input unit (camera) 111, extracts the face of a person included in the image, and generates the location information of the face as the probability distribution data. To be more specific, the unit generates an expected value and dispersion data N (mₑ, σₑ) pertaining to the location and direction of the face.

Furthermore, as shown in FIG. 12, in the information processing device 500 of the present embodiment, the audio event detecting unit 122 has an audio-based speech recognition processing unit 522, and the image event detecting unit 112 has an image-based speech recognition processing unit 512.

The audio-based speech recognition processing unit 522 of the audio event detecting unit 122 analyzes the audio information input from the audio input units (microphones) 121a to 121d, performs the comparison process of the audio information to words registered in a word recognition dictionary stored in a database 510, and executes ASR (Audio Speech Recognition) as an audio-based speech recognition process. In other words, the audio recognition process is performed in which what kind of words is spoken is identified, and information is generated regarding a word that is estimated to be spoken with a high probability (ASR information). Furthermore, the audio recognition process can be applied in this process, for example, to which the Hidden Markov Model (HMM) known from the past is applied.

In addition, the image-based speech recognition processing unit 512 of the image event detecting unit 112 analyzes the image information input from the image input unit (camera) 111, and then further analyzes the movement of the user's mouth. The image-based speech recognition processing unit 512 analyzes the image information input from the image input unit (camera) 111 and generates mouth movement information corresponding to a target (tID=1 to n) included in the image. In other words, VSR (Visual Speech Recognition) information is generated with the VSR.

The audio-based speech recognition processing unit 522 of the audio event detecting unit 122 executes Audio Speech Recognition (ASR) as an audio-based speech recognition process, and inputs information (ASR information) of a word that is estimated to be spoken with high probability to an audio-image-combined speech recognition score calculating unit (AVSR score calculating unit) 530.

In the same manner, the image-based speech recognition processing unit 512 of the image event detecting unit 112 executes Visual Speech Recognition (VSR) as an image-based speech recognition process and generates information pertaining to mouth movements as a result of VSR (VSR information) to input to the audio-image-combined speech recognition score calculating unit (AVSR score calculating unit) 530. The image-based speech recognition processing unit 512 generates VSR information that includes at least the viseme information indicating the shape of the mouth in a period corresponding to a speech period of a word detected by the audio-based speech recognition processing unit 522.

In the audio-image-combined speech recognition score calculating unit (AVSR score calculating unit) 530, an Audio Visual Speech Recognition (AVSR) score is calculated which is a score to which both of the audio information and the image information are applied with the application of the ASR information input from the audio-based speech recognition processing unit 522 and the VSR information generated by the image-based speech recognition processing unit 512, and the score is input to the audio-image integration processing unit 131.

In other words, the audio-image-combined speech recognition score calculating unit (AVSR score calculating unit) 530 inputs word information from the audio-based speech recognition processing unit 522, inputs the mouth movement information in a unit of user from the image-based speech recognition processing unit 512, executes a score setting process in which a high score is set to the mouth movement close to the word information, and executes the score (AVSR score) setting process in the unit of user.

To be more specific, by comparing registered viseme information and the viseme information in the unit of user included in the VSR information by a phoneme unit constituting the word information included in the ARS information, a viseme score setting process is performed in which a viseme with high similarity is assigned with a high score, and furthermore a calculation process of an arithmetic mean or a geometric mean is performed for the viseme scores corresponding to all phonemes constituting words, and thereby an AVSR score which corresponds to a user is calculated. A specific process example thereof will be described with reference to drawings later.

Furthermore, the AVSR score calculation process can be applied with the audio recognition process to which Hidden Markov Model (HMM) is applied in the same manner as in the ASR process. In addition, for example, the process disclosed in [http://www.clsp.jhu.edu/ws2000/final_reports/avsr/ws00avsr.pdf] can be applied thereto.

The AVSR score calculated by the audio-image-combined speech recognition score calculating unit (AVSR score calculating unit) 530 is used as a score corresponding to a face attribute score described in the previous subject [1. regarding the outline of user locations and user identification process by the particle filtering based on audio and image event detection information]. In other words, the score is used in the speaker specification process.

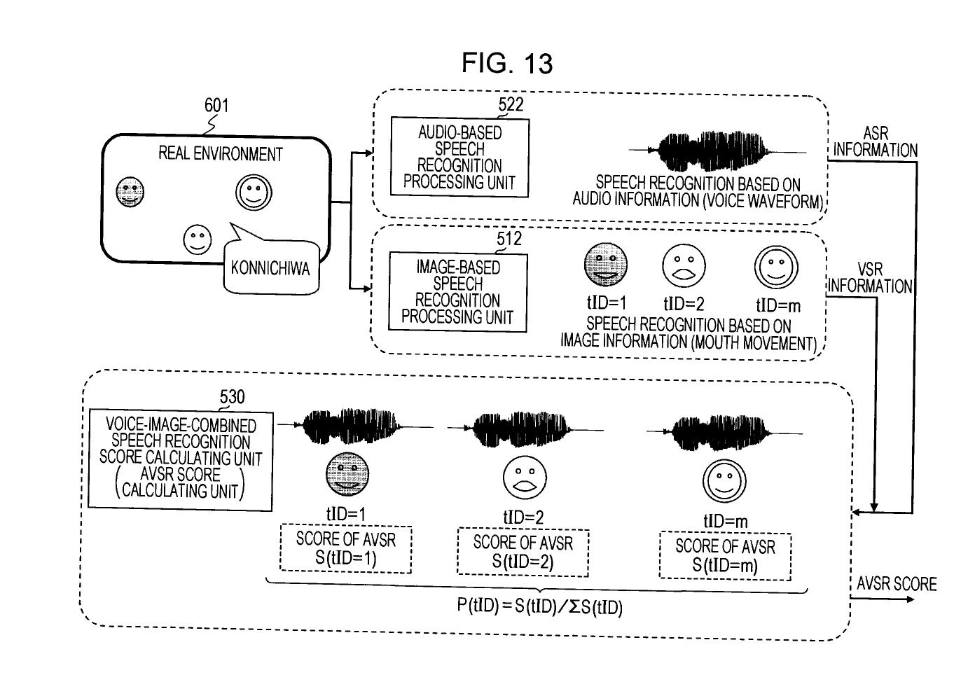

Referring to FIG. 13, the ARS information, the VSR information, and an example of the AVSR score calculating process will be described.

A real environment 601 shown in FIG. 13 is an environment set with microphones and a camera as shown in FIG. 1. A plurality of users (three users in this example) is photographed by the camera, and the word “konnichiwa (good afternoon)” is acquired via the microphones.

The audio signal acquired via the microphones is input to the audio-based speech recognition processing unit 522 in the audio event detecting unit 122. The audio-based speech recognition processing unit 522 executes an audio-based speech recognition process [ASR], and generates the information of the word that is estimated to be spoken with a high probability (ASR information) to input to the audio-image integration processing unit 131.

In this example, the information of the word “konnichiwa” is input to the audio-image-combined speech recognition score calculating unit (AVSR score calculating unit) 530 as ASR information as long as noise or the like are not particularly included in the information.

On the other hand, the image signal acquired via the camera is input to the image-based speech recognition processing unit 512 in the image event detecting unit 112. The image-based speech recognition processing unit 512 executes an image-based speech recognition process [VSR]. Specifically, as shown in FIG. 13, when a plurality of users [target (tID=1 to 3)] is included in the acquired image, the movements of the mouths of each of the users [target (tID=1 to 3)] are analyzed. The analyzed information of the mouth movements in the unit of user is input to the audio-image-combined speech recognition score calculating unit (AVSR score calculating unit) 530 as VSR information.

The audio-image-combined speech recognition score calculating unit (AVSR score calculating unit) 530 calculates an Audio Visual Speech Recognition (AVSR) score that is a score to which both of the audio information and the image information are applied with the application of the ASR information input from the audio-based speech recognition processing unit 522 and the VSR information generated by the image-based speech recognition processing unit 512, and inputs the score to the audio-image integration processing unit 131.

The AVSR score is calculated as a score corresponding to each of the users [target (tID=1 to 3)] and input to the audio-image integration processing unit 131.

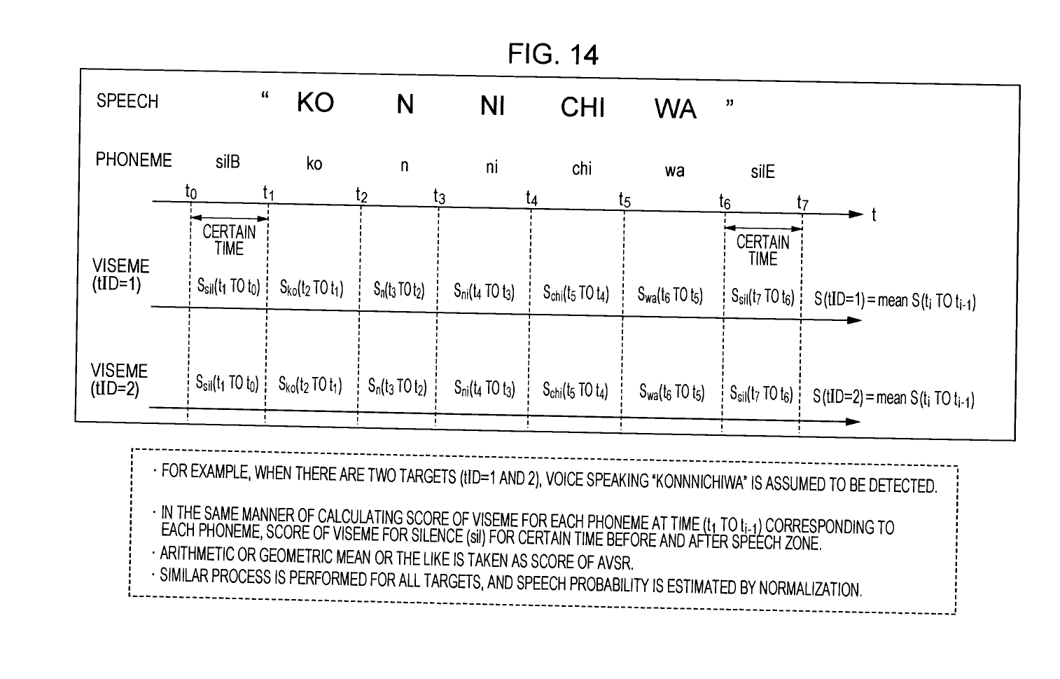

Referring to FIG. 14, an example of the AVSR score calculating process executed by the audio-image-combined speech recognition score calculating unit (AVSR score calculating unit) 530 will be described.

In the example shown in FIG. 14, the ASR information input from the audio-based speech recognition processing unit 522, that is, the word recognized as a result of the voice analysis is “konnichiwa,” and the example is of a process example where the information of individual mouth movements (viseme) corresponding to two users [target (tID=1 and 2) is obtained as the VSR information input from the image-based speech recognition processing unit 512.

The audio-image-combined speech recognition score calculating unit (AVSR score calculating unit) 530 calculates an AVSR score for each of the targets (tID=1 and 2) in accordance with the processing steps below.

(Step 1) A score of a viseme is calculated for each phoneme at a time (tᵢ to tᵢ₋₁) corresponding to each phoneme.

(Step 2) An AVSR score is calculated with an arithmetic mean or a geometric mean.

Furthermore, by the process described above, after an AVSR score corresponding to the plurality of targets is calculated, a normalizing process is performed and the normalized AVSR score data are input to the audio-image integration processing unit 131.

As shown in FIG. 14, the VSR information input from the image-based speech recognition processing unit 512 is the information of the movements of individual mouths (viseme) corresponding to the users [target (tID=1 and 2)].

The VSR information is the information of mouth shapes at a time (tᵢ to tᵢ₋₁) corresponding to each letter unit (each phoneme) in a time (t₁ to t₆) when the ASR information of “konnichiwa” input from the audio-based speech recognition processing unit 522 is spoken.

In the above (Step 1), the audio-image-combined speech recognition score calculating unit (AVSR score calculating unit) 530 calculates scores of visemes (S(tᵢ to tᵢ₋₁)) corresponding to each of the phonemes based on the determination whether the shapes of the mouth corresponding to each of the phonemes are close to the shapes of the mouth uttering each of the phonemes [ko] [n] [ni] [chi] [wa] of the ASR information of [konnichiwa] input from the audio-based speech recognition processing unit 522.

Furthermore, in the above (Step 2), the AVSR scores are calculated with the arithmetic or geometric mean values of all scores.

In the example of FIG. 14,

the AVSR score S (tID=1) of a user of target ID=1 (tID=1) is:

S(tID=1)=mean S((tᵢ to tᵢ₋₁), and

the AVSR score S (tID=2) of a user of target ID=2 (tID=2) is:

S(tID=2)=mean S((tᵢ to tᵢ₋₁).

Furthermore, the example shown in FIG. 14 illustrates that the VSR information input from the image-based speech recognition processing unit 512 includes not only the information of mouth shapes at times (tᵢ to tᵢ₋₁) corresponding to each letter unit (each phoneme) within the times (t₁ to t₆) when the ASR information of [konnichiwa] input from the audio-based speech recognition processing unit 522 but also the viseme information of times (t₀ to t₁ and t₆ to t₇) in silent states before and after the speech.

As such, the AVSR scores of each target may be calculated values that include viseme scores of the silent states before and after the speech time of the word “konnichiwa”.

Furthermore, the scores of the actual speech period, that is, speech period of each phoneme [ko] [n] [ni] [chi] [wa], is calculated as scores of the visemes (S(tᵢ to tᵢ₋₁)) corresponding to each phoneme based on whether the visemes are close to the shapes of the mouth uttering each phoneme of [ko] [n] [ni] [chi] [wa]. On the other hand, with regard to viseme scores of the silent states, for example, the viseme score of time t₀ to t₁, shapes of the mouth before and after the speech of “ko” are stored in a database 501 as registered information and a high score is set to a shape of the mouth as the shape is close to the registered information.

In the database 501, for example, the following registered information of mouth shapes in a phoneme unit (viseme information) is recorded as registered information of mouth shapes for each word.

ohayou (good morning): o-ha-yo-u

konnichiwa (good afternoon): ko-n-ni-chi-wa

The audio-image-combined speech recognition score calculating unit (the AVSR score calculating unit) 530 sets a high score to the mouth shapes as the shapes are close to the registered information.

Furthermore, as a data generation process for calculating the scores based on mouth shapes, a phoneme HMM learning process in the learning process of Hidden Markov Model (HMM) for word recognition which is known as a general approach to audio recognition is effective. For example, in the same approach as the configuration disclosed in Chapters 2 and 3 of the IT Text Voice Recognition System ISBN4-274-13228-5, the viseme HMM can be learned when the word HMM is learned. At this time, if common phonemes and visemes are defined with ASR and VSR as below, the VSR score of silence can be calculated.

$$a \text{:} a ( phoneme )$$

$$ka \text{:} ka ( phoneme )$$

$$…$$

$$sp \text{:} silence ( middle of a sentence )$$

$$q \text{:} silence ( geminate consonant )$$

$$silB \text{:} silence ( head of a sentence )$$

$$silE \text{:} silence ( end of a sentence )$$

Furthermore, when the Hidden Markov Model (HMM) is learned, as there are “one phoneme (monophone)” and “three consecutive phonemes (triphone)” in phonemes, correspondence relationships such as “one viseme” and “three consecutive visemes” in visemes is also preferably used by being recorded in a database as learning data.

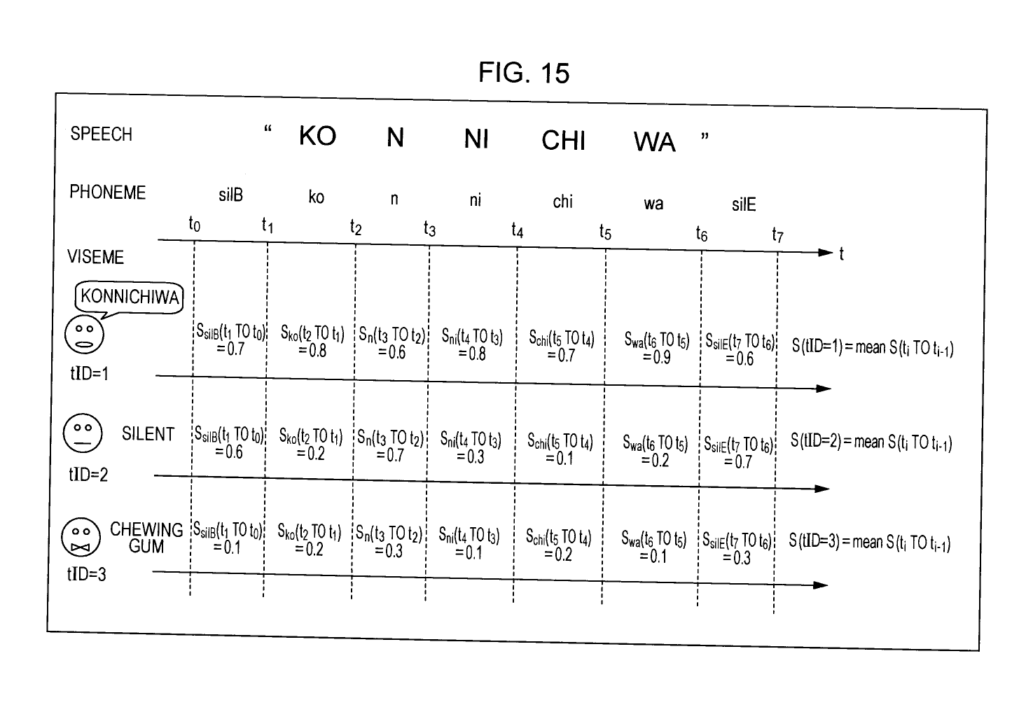

Referring to FIG. 15, a process example of AVSR score calculation in a case where an image input from the image input unit (camera) 111 includes three users [target (tID=1 to 3)] and one person (tID=1) in the users actually speaks “konnichiwa” will be described.

In the example shown in FIG. 15, each of the three targets (tID=1 to 3) is set as below.

tID=1 speaks “konnichiwa”.

tID=2 continues in silence.

tID=3 chews gum.

Under such a setting, in the process of previously described subject [1. Regarding the outline of user locations and user identification process by particle filtering based on audio and image event detection information], since the face attribute information (face attribute score) is determined based on the extent of a movement of a mouth, it is possible that the score of the target tID=3 that chews gum is set highly.

However, with regard to the AVSR score calculated in this process example, the score of a target having mouth movements closer to “konnichiwa” that is a spoken word detected by the audio-based speech recognition processing unit 522 (AVSR score) becomes high.

In the example shown in FIG. 15, in the same manner as in the example shown in FIG. 14, with regard to the scores for the speech periods of each phoneme of [ko] [n] [ni] [chi] [wa], scores of visemes (S(tᵢ to tᵢ₋₁)) corresponding to each phoneme is calculated based on whether the visemes are close to the shapes of the mouth uttering each phoneme of [ko] [n] [ni] [chi] [wa]. Even in the silent state, for example, with regard to the viseme score of time t₀ to t₁, the shapes of the mouth before and after the speech of “ko” are stored in a database 501 as registered information and a high score is set to a shape of the mouth as the shape is close to the registered information, in the same manner as in the above-described process.

As a result, as shown in FIG. 15, the viseme score (S(tᵢ to tᵢ₋₁)) of the user of tID=1 that actually speaks “konnichiwa” exceeds the viseme scores of other targets (tID=2 and 3) in all times.

Therefore, also with regard to the finally calculated AVSR score, the AVSR score of the target (tID=1):[S(tID=1)=mean S(tᵢ to tᵢ₋₁)] has a value exceeding the scores of other targets.

The AVSR score corresponding to the target is input to the audio-image integration processing unit 131. In the audio-image integration processing unit 131, the AVSR score is used as a score value substituting the face attribute score described in the above subject no. 1, and the speaker specification process is performed. In the process, the user who actually speaks can be specified with high accuracy.

Furthermore, as described in the previous subject no. 1, for example, there is a case where mouth movements are not able to be detected even though the face is detected because the mouth is covered by a hand. In that case, the VSR information of the target is not able to be acquired. In such a case, a prior knowledge value [Sₚᵣᵢₒᵣ] is applied only to such a period instead of the viseme score (S(tᵢ to tᵢ₋₁)).

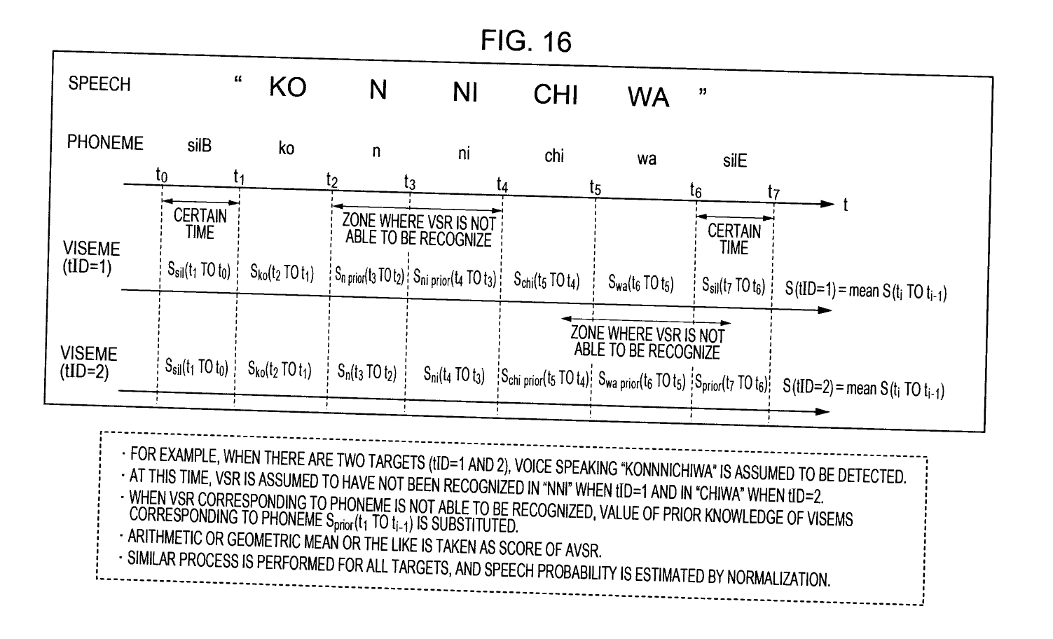

The process example will be described with reference to FIG. 16.

In the same manner as in the process example of the above-described FIG. 14, in the example shown in FIG. 16, the ASR information input from the audio-based speech recognition processing unit 522, that is, the word recognized as a result of voice analysis is “konnichiwa”, and there is a process example in which the information of individual mouth movements (viseme) corresponding to two users [targets (tID=1 and 2)] as the VSR information input from the image-based speech recognition processing unit 512 is obtained.

However, for the target of tID=1, mouth movements are not able to be observed in the period of time t₂ to t₄. Similarly, for the target of tID=2, mouth movements are not able to be observed in the period before the time t₅ until the time after t₆.

In other words, viseme scores are not able to be calculated in “nni” for the target of tID=1 and in “chiwa” for the target of tID=2.

In such a period that the viseme scores are not able to be calculated, prior knowledge values [S_{prior(ti to ti-1)}] for visemes corresponding to phonemes are substituted.

Furthermore, for example, the following values can be applied as the prior knowledge values [S_{prior(ti to ti-1)}] for visemes.

a) Arbitrary fixed value (0.1, 0.2, or the like)

b) Uniform value (1/N) for all visemes (N)

c) Appearance probability set according to appearance frequency of all visemes measured beforehand

Such values are registered in the database 501 in advance.

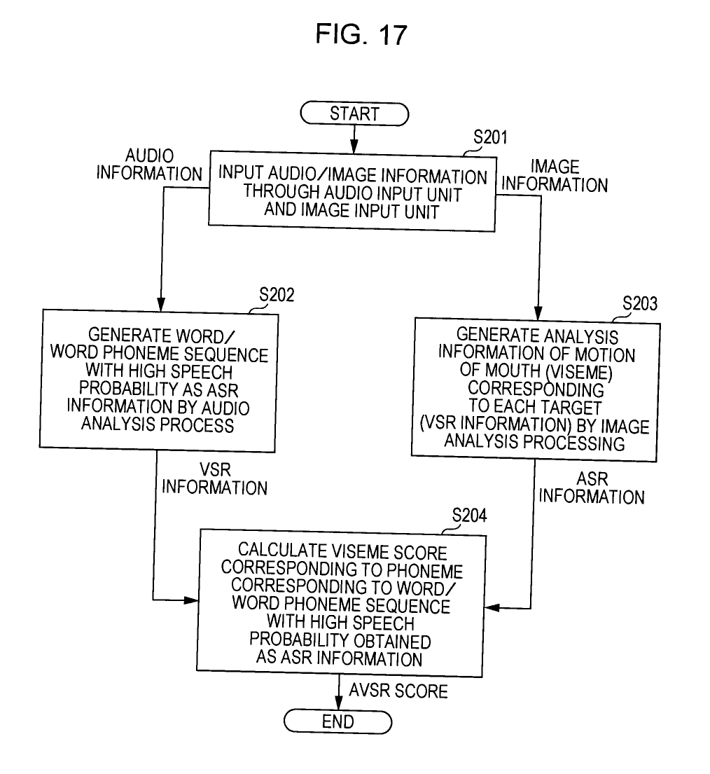

Next, a process sequence of AVSR score calculation process will be described with reference to the flowchart shown in FIG. 17. Furthermore, the principal agents executing the flow shown in FIG. 17 are the audio-based speech recognition processing unit 522, the image-based speech recognition processing unit 512, and the audio-image-combined speech recognition score calculating unit (AVSR score calculating unit) 530.

First, in Step S201, audio information and image information is input through the audio input units (microphones) 121a to 121d shown in FIG. 15 and the image input unit (camera) 111. The audio information is input to the audio event detecting unit 122 and the image information is input to the image event detecting unit 112.

Step S202 is a process of the audio-based speech recognition processing unit 522 of the audio event detecting unit 122. The audio-based speech recognition processing unit 522 analyzes the audio information input from the audio input units (microphones) 121a to 121d, performs a comparison process with the audio information corresponding to words registered in a word recognition dictionary stored in the database 501, and executes ASR (Audio Speech Recognition) as an audio-based speech recognition process. In other words, the audio-based speech recognition processing unit 522 executes an audio recognition process in which what kind of word is spoken is identified, and generates information of a word that is estimated to be spoken with a high probability (ASR information).

Step S203 is a process of the image-based speech recognition processing unit 512 of the image event detecting unit 112. The image-based speech recognition processing unit 512 analyzes the image information input from the image input unit (camera) 111, and further analyzes the mouth movements of a user. The image-based speech recognition processing unit 512 analyzes the image information input from the image input unit (camera) 111 and generates the mouth movement information corresponding to targets (tID=1 to n) included in the image. In other words, the VSR information is generated by applying VSR (Visual Speech Recognition).

Step S204 is of a process of the audio-image-combined speech recognition score calculating unit (AVSR score calculating unit) 530. The audio-image-combined speech recognition score calculating unit (AVSR score calculating unit) 530 calculates an AVSR (Audio Visual Speech Recognition) score to which both of the audio information and the image information are applied with the application of the ASR information generated by the audio-based speech recognition processing unit 522 and the VSR information generated by the image-based speech recognition processing unit 512.

This score calculation process has been described with reference to FIGS. 14 to 16. For example, the score of the visemes S(tᵢ to tᵢ₋₁) corresponding to each phoneme is calculated based on whether the visemes are close to the shapes of the mouth uttering each of the phonemes [ko] [n] [ni] [chi] [wa] of the ASR information of “konnichiwa” input from the audio-based speech recognition processing unit 522, and the AVSR score is calculated with the arithmetic or geometric mean values and the like of the viseme score (S(tᵢ to tᵢ₋₁)). Further, an AVSR score corresponding to each target that has undergone normalization is calculated.

Furthermore, the AVSR score calculated by the audio-image-combined speech recognition score calculating unit (AVSR score calculating unit) 530 is input to the audio-image integration processing unit 131 shown in FIG. 12 and applied to the speaker specification process.

Specifically, the AVSR score is applied instead of the face attribute information (face attribute score) previously described in the subject no. 1, and the particle updating process is executed based on the AVSR score.

Similar to the face attribute information (face attribute score [S_{eID}]), the AVSR score is used finally as the [signal information] indicating an event generation source. If a certain number of events are input, the weight of each particle is updated, the weight of the particle that has the data closest to the information in the real space gets greater, and the weight of the particle that has data unsuitable for the information in the real space gets smaller. As such, at the stage that a deviation occurs in the weight of the particle and converges, the signal information based on the face attribute information (face attribute score), that is, the [signal information] indicating the event generation source, is calculated.

In other words, after the particle updating process, the AVSR score is applied to the signal information generation process in the process of Step S108 in the flowchart shown in FIG. 10.

The process of Step S108 of the flow shown in FIG. 8 will be described. The audio-image integration processing unit 131 calculates the probability that each of n targets (tID=1 to n) is an event generation source in Step S108, and outputs the result to the process determining unit 132 as the signal information.

As previously described, the [signal information] indicating an event generation source is data indicating who spoke, in other words, indicating the [speaker] in an audio event, and the data indicating whose the face included in the image is and who the [speaker] is in an image event.

The audio-image integration processing unit 131 calculates a probability that each target is an event generation source based on the number of hypothesis targets of the event generation source set in each particle. In other words, the probability that each of the targets (tID=1 to n) is an event generation source is assumed to be [P(tID=i)]. Wherein, i is 1 to n. For example, as previously described, the probability that the generation source of an event (eID=x) is a specific target y (tID=y) is expressed by:

P_{eID=x}(tID=y),

and the probability equivalent to the ratio of the number of particles (=m) set in the audio-image integration processing unit 131 to the number of assigned targets to each event. For example, in the example shown in FIG. 5, the correspondence relationships are established as below.

P_{eID=1}(tID=1)=[the number of particles for which tID=1 is assigned to the first event (eID=1)/(m)];

P_{eID=1}(tID=2)=[the number of particles for which tID=2 is assigned to the first event (eID=1)/(m)];

P_{eID=2}(tID=1)=[the number of particles for which tID=1 is assigned to the second event (eID=2)/(m)]; and

P_{eID=2}(tID=2)=[the number of particles for which tID=2 is assigned to the second event (eID=2)/(m)].

The data is output to the process determining unit 132 as the [signal information] indicating the event generation source.

In the process example as above, an AVSR score of each target is calculated by the process in which an audio-based speech recognition process and image-based speech recognition process are combined, the specification of the speech source is executed with application of the AVSR score, and therefore, the user (target) showing mouth movements according to actual speech content can be determined to be the speech source with high accuracy. With the estimation of the speech source as such, the performance of diarization as a speaker specification process can be improved.

Hereinabove, the present invention has been described in detail with reference to specific embodiments. However, it is obvious that a person skilled in the art can perform modification and substitution of the embodiments in the range not departing from the gist of the invention. In other words, the invention has been disclosed in the form of an exemplification, and is not supposed to be interpreted to a limited extent. The claims of the invention are supposed to be taken into consideration in order to judge the gist of the invention.

In addition, a series of processes described in this specification can be executed by hardware, software, or a combined composition of both. When the processes are executed by software, a program recording the process sequence therein can be executed by being installed in memory on a computer incorporated in dedicated hardware, or a program can be executed by being installed in a general-purpose computer that can execute various processes. For example, such a program can be recorded in a recording medium in advance. In addition to installing the program into a computer from a recording medium, the program can be received via a network such as LAN (Local Area Network) or the Internet, and can be installed in a recording medium such as built-in hard disks or the like.

Furthermore, various processes described in the specification may be executed not only in the time series in accordance with the description but also in parallel or individually according to the process performance of a device executing the process or to necessity. In addition, the system in this specification has logically assembled the composition of a plurality of devices, and each of the constituent devices is not limited to be in the same housing.

The present application contains subject matter related to that disclosed in Japanese Priority Patent Application JP 2010-054016 filed to the Japan Patent Office on Mar. 11, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
an audio-based speech recognition processing unit which is input with audio information as observation information of a real space, executes an audio-based speech recognition process, thereby generating word information that is determined to have a high probability of being spoken;
an image-based speech recognition processing unit which is input with image information as observation information of the real space, analyzes mouth movements of each user included in the input image, thereby generating mouth movement information in a unit of user;
an audio-image-combined speech recognition score calculating unit which is input with the word information from the audio-based speech recognition processing unit and input with the mouth movement information in a unit of user from the image-based speech recognition processing unit, executes a score setting process in which a mouth movement close to the word information is set with a high score, thereby executing a score setting process in a unit of user; and
an information integration processing unit which is input with the score and executes a speaker specification process based on the input score.

2. The information processing device according to claim 1,
wherein the audio-based speech recognition processing unit executes ASR (Audio Speech Recognition) that is an audio-based speech recognition process to generate a phoneme sequence of word information that is determined to have a high probability of being spoken as ASR information,
wherein the image-based speech recognition processing unit executes VSR (Visual Speech Recognition) that is an image-based speech recognition process to generate VSR information that includes at least viseme information indicating mouth shapes in a word speech period, and
wherein the audio-image-combined speech recognition score calculating unit compares the viseme information in a unit of user included in the VSR information with registered viseme information in a unit of phoneme constituting the word information included in the ASR information to execute a viseme score setting process in which a viseme with high similarity is set with a high score, and calculates an AVSR score which is a score corresponding to a user by the calculation process of an arithmetic mean value or a geometric mean value of a viseme score corresponding to all phonemes further constituting a word.

3. The information processing device according to claim 2, wherein the audio-image-combined speech recognition score calculating unit performs a viseme score setting process corresponding to periods of silence before and after the word information included in the ASR information, and calculates an AVSR score which is a score corresponding to a user by the calculation process of an arithmetic mean value or a geometric mean value of a score including a viseme score corresponding to all phonemes constituting a word and a viseme score corresponding to a period of silence.

4. The information processing device according to claim 2 or 3, wherein the audio-image-combined speech recognition score calculating unit uses a value of prior knowledge that is set in advance as a viseme score for a period when viseme information indicating shapes of the mouth of the word speech period is not input.

5. The information processing device according to any one of claims 1 to 4, wherein the information integration processing unit sets probability distribution data of a hypothesis on user information of the real space and executes a speaker specification process by updating and selecting a hypothesis based on the AVSR score.

6. The information processing device according to any one of claims 1 to 5, further comprising:
an audio event detecting unit which is input with audio information as observation information of the real space and generates audio event information including estimated location information and estimated identification information of a user existing in the real space; and
an image event detecting unit which is input with image information as observation information of the real space and generates image event information including estimated location information and estimated identification information of a user existing in the real space,
wherein the information integration processing unit sets probability distribution data of a hypothesis on location and identification information of a user and generates analysis information including location information of a user existing in the real space by updating and selecting a hypothesis based on the event information.

7. The information processing device according to claim 6, wherein the information integration processing unit is configured to generate analysis information including location information of a user existing in the real space by executing a particle filtering process to which a plurality of particles set with plural pieces of target data corresponding to virtual users are applied, and
wherein the information integration processing unit is configured to set each piece of the target data set in the particles in association with each event input from the audio and the image event detecting units and to update target data corresponding to the event selected from each particle according to an input event identifier.

8. The information processing device according to claim 7, wherein the information integration processing unit performs a process by associating each event in a unit of face image detected by the event detecting units.

9. An information processing method which is implemented in an information processing device comprising the steps of:
processing audio-based speech recognition in which an audio-based speech recognition processing unit is input with audio information as observation information of a real space, executes an audio-based speech recognition process, thereby generating word information that is determined to have a high probability of being spoken;
processing image-based speech recognition in which an image-based speech recognition processing unit is input with image information as observation information of a real space, analyzes mouth movements of each user included in the input image, thereby generating mouth movement information in a unit of user;
calculating an audio-image-combined speech recognition score in which an audio-image-combined speech recognition score calculating unit is input with the word information from the audio-based speech recognition processing unit and input with the mouth movement information in a unit of user from the image-based speech recognition processing unit, executes a score setting process in which a mouth movement close to the word information is set with a high score, and thereby executing a score setting process in a unit of user; and
processing information integration in which an information integration processing unit is input with the score and executes a speaker specification process based on the input score.

10. A program which causes an information processing device to execute an information process comprising the steps of:
processing audio-based speech recognition in which an audio-based speech recognition processing unit is input with audio information as observation information of a real space, executes an audio-based speech recognition process, thereby generating word information that is determined to have a high probability of being spoken;
processing image-based speech recognition in which an image-based speech recognition processing unit is input with image information as observation information of a real space, analyzes mouth movements of each user included in the input image, and thereby generating mouth movement information in a unit of user;
calculating an audio-image-combined speech recognition score in which an audio-image-combined speech recognition score calculating unit is input with the word information from the audio-based speech recognition processing unit and input with the mouth movement information in a unit of user from the image-based speech recognition processing unit, executes a score setting process in which a mouth movement close to the word information is set with a high score, thereby executing a score setting process in a unit of user; and
processing information integration in which an information integration processing unit is input with the score and executes a speaker specification process based on the input score.
